(19) United States
(12) Patent Application Publication
(10) Pub. No.: US 2012/0036015 A1
(43) Pub. Date: Feb. 9, 2012

(54) RELEVANCY OF ADVERTISING MATERIAL THROUGH USER-DEFINED PREFERENCE FILTERS, LOCATION AND PERMISSION INFORMATION

(76) Inventor: OMAR M. SHEIKH, OTTAWA (CA)

(21) Appl. No.: 13/177,448

(22) Filed: Jul. 6, 2011

Related U.S. Application Data
(60) Provisional application No. 61/361,786, filed on Jul. 6, 2010.

(51) Int. Cl. G06Q 30/02

(52) U.S. Cl. 705/14.54; 705/14.64; 705/14.58; 705/14.57; 705/14.56

(57) ABSTRACT

The present invention provides methods to improve the relevancy of rendered advertising material to one or more consumers based on user-defined preferences, geolocation, and user-granted permission. The present invention achieves this through the presentation of exemplary methods for: i) the consolidation of advertisement information to include description, inventory, price, quantity and geolocation information of one or more merchants in a commerce network; ii) the delivery of relevant advertising material to one or more consumers using preference filters that can specify one or more merchants, merchant locations, products and services, and/or regions of interest at any time; and, iii) the presentation of location-based advertisements that are based on consumer-based permission and preference filters. These methods improve the user-targeting, geographic and time relevancy of advertisements by connecting merchants with relevant consumers who are looking to purchase items at that point in time.

### RELATED APPLICATION

This application is a continuation-in-part of application Ser. No. 61/361,786, filed Jul. 6, 2010, entitled “Improving Sales Distribution through Delivery of Personalized Sales Content in an Ad System.”

### BACKGROUND OF INVENTION

1. Field of Invention

The present invention generally relates to advertising, and more particularly to improving the relevancy of rendered advertising material based on: i) user-defined preferences, ii) geolocation, and iii) user-granted permission.

2. Related Art

In the current sales environment, consumers receive advertising from a number of media streams at any time including flyers, billboards, magazines, newspapers, radio, and television, among others. Website and mobile advertising have also grown substantially where ad impressions are typically displayed in banner format to a browsing user; an ad impression is defined as a single view by a user. Advertising on social networks like Facebook™ that targets user browsing behavior and static profile interests is also growing. However, as new technologies emerge, the number of advertising mediums will inevitably increase with the need for monetization.

The result of this plethora of advertising is an overload in the information space for a user, or consumer. Typically, advertisements take the form of sales promotional information to provide users with discounts, or specials, as an incentive for them to try a merchant's products and/or services. However, response rates to advertisements decrease with a growing number of advertisers competing for consumer attention¹. Consequently, merchants, or advertisers, suffer. Consumers are also at a disadvantage as it becomes increasingly difficult to find relevant advertising material to their immediate purchase interests. This leads to an inability for consumers to get what they need, when they need it and at the best price. ¹ Chen, Y. C., Shang, R. A., and Kao, C. Y., 2009. The effects of information overload on consumers' subjective state towards buying decision in the Internet shopping environment. Electronic Commerce Research and Applications, 8 (1), 48-58.

One attempt in the art to address the relevancy of advertisements to a user is U.S. Pat. No. 7,668,832 B2. In this patent, Yeh et al. discuss systems and methods to use geolocation information to provide businesses with a more relevant audience for an advertisement. However, the patent has a few limitations. Firstly, the patent is limited in its use of geolocation targeting information associated with an advertisement. Relevancy of an advertisement to a user is formed of: i) the immediate purchase preferences of the user; ii) geographical relevancy; and, iii) time relevancy associated with the request, i.e., whether or not the user is currently interested in receiving the advertisement. Yeh et al. only consider geographical relevancy by considering geolocation targeting information of the advertisement. While the Google™ keyword ad server enables advertisers to target keywords of user search queries for the rendering of the advertisement, search queries do not always reflect purchase interests of the user or the desire of the user to be delivered advertising material at that time. Secondly, this patent is limited in its use of a score that uses geolocation price information associated with the advertisement that controls the serving of the advertisement to a user client. By rendering the advertisement based on score, Yeh et al. ensure that advertisements that have less attractive price information, but may be more relevant to the user's current purchase interests, are not displayed to the user. Removing price information from the algorithm will lead to more relevant advertisements being rendered to the user.

A second attempt in the art to improve the relevancy of advertisements is U.S. Pat. No. 7,890,501 B2. In this patent, Lunt et al. provide advertisements, which they call sponsored links, and algorithmic search results in response to queries that are marked based on the frequency of clicks by members of the social network. To improve the relevancy of the advertisement to the user in question, markers consider the frequency of clicks within a predetermined degree of separation from the user; a degree of separation defines the relatedness between two members of a social network, in the form of a minimum count of the intermediate members in a relationship between two individuals. However, while considering related actions of users within the social network to a search result may improve relevancy and trust associated with the search result, the patent has a few shortcomings. Firstly, advertisers again bid on keywords of a query with larger bids taking a higher position in search results. As a result, pricing information impacts the ranking of the advertisement and may have an adverse effect on the relevancy of the advertisement to the user's immediate purchase interests. Even if the query is associated with static interest information associated with the user's profile such as “soccer,” “traveling,” “reading”, for example, rendering advertisements based on this information reflects neither the immediate purchase interests of the user, nor the desire of the user to be delivered advertising material at that time. Secondly, while advertisers may be able to specify geolocation targeting information associated with their advertisement, such as the city of San Francisco, for example, this information will likely not help the consumer find participating locations at which the advertisement is applicable. Thirdly, this patent does not cover methods for a user to directly recommend advertisements to one or more members of their social network within a predetermined degree of separation who may be interested in the advertisement. For example, if a user, call him Harry, comes across an advertisement for a perfume that he recalls his friend Sally mentioning that she enjoys, this art does not cover a direct recommendation of the relevant advertisement from Harry to Sally. Rather, this art covers Harry's click on the advertisement, which Sally may observe as part of Harry's social network based on the bidding outcome and frequency of clicks of competing advertisements as discussed above.

A third attempt in the art to improve the relevancy of recommended content to a user is patent application number US 2007/0038659 A1. In this application, Datar and Garg provide methods and apparatus to create a recommender system for personalization of a user's browsing experience such as by presenting related news articles that they may be interested in. Approaches using the minhash method for clustering users with the aim of performing collaborative filtering are covered, i.e. by monitoring a user's click history, purchase history or items added to a user's shopping cart, and clustering users with similar activity (or interests in items) together, recommendations may be provided based on the activity of the other users in the cluster. User clustering for the purpose of creating a recommender system using community data is not directly related to the material covered in this patent; however, we submit it as prior art due to its use of user clustering to aggregate users with similar interests for ease of search. This application takes k permutations of hash values of a user's interest set, such as by the minhash method for clustering users, to form a representation of user interests in relation to other users. The hash value for permutation k is taken as the minimum element of the hash, i.e. the minhash value. Multiple users with the same hash values are deemed to have similar interests and are placed in the same cluster. These grouped users who perform actions (clicking on items, purchasing items, adding items to the shopping cart, etc.) are considered in recommending new items to the user in the cluster that the system deems relevant to the user's interests. The application of these methods for Google News personalization is presented in a Google™ paper². The patent application has a few limitations for our purposes. Firstly, the recording of actions expressing user interests such as click history, purchase history or items added to a shopping cart aims to deduce items that the user may be interested in. However, removing the recommendation engine and pushing content to the user that indeed meets their immediate purchase interests based on self-defined preferences will yield more relevant content in a commerce network. Secondly, performing collaborative filtering using community data to present related items viewed by users with similar interests does not address the user's unique preferences as an individual. However, enabling users to set specifically what they are looking for will improve the relevance of delivered content. ² A. S. Das, M. Datar, A. Garg and S. Rajaram. Google news personalization: scalable online collaborative filtering. In Proceedings of WWW 2007, ACM Press. 271-280, 2007.

A fourth attempt in the art is U.S. Pat. No. 7,693,752 B2 that covers subscription-based systems for providing commerce-related information from one or more merchants to one or more mobile devices. In this patent, Jaramillo covers methods to receive merchant information based on geographic location on one or more mobile devices. The patent strictly covers a user-inputted search for a merchant type, and receiving associated information for the merchant including the merchant's name, physical locations of the merchant and a promotional offer offered by the merchant on a mobile device. As a result, this patent has a few limitations for our purposes. Firstly, restricting the solution to a user-inputted search for a merchant type reduces the effectiveness of the system, as users are more likely to be interested in searching for specific items on sale and where they are the cheapest, than general categories such as food, entertainment health and beauty, and travel type merchants. Secondly, while Jaramillo covers promotions, incentives, advertisements and coupons that may be associated with the merchant information, Jaramillo does not specify the form of the promotional offer, whether including text, images, video, embedded items, etc. As a result, the systems and methods of this patent do not cover methods to improve the user search for merchant information; if sales promotional information is defined as containing embedded description information, related items for which the advertisement applies, remaining quantity information associated with the items, and information related to participating locations at which the advertisement is applicable, the efficiency of a user search to find specific items of interest (and associated price information) based on location would be improved. Thirdly, Jaramillo does not provide systems and methods to improve the relevancy of advertising material based on self-defined user preferences in the system, geographical information regarding merchant locations that have items of interest in stock, and user-based permission of advertisements. Fourthly, the claims of methods to perform location-based search is an obvious extension of any merchant application given the current popularity of mobile devices. Fifthly, the patent only covers: promotional offers offered by the merchant as an incentive for the user to visit the physical location of the merchant and to demonstrate the user's membership to the shopping network to receive a discount. However, removing this limitation enables users to make mobile-based purchases on items of interest which does not require them to physically visit the location to make a purchase. Also, by not restricting promotional offers to be redeemed by members exclusively enables merchants to use the system to complement their existing marketing initiatives by opening up offers to the public.

### Sales Promotion

Several entities on the Internet aim to organize sales promotional information including a number of bargain shopping websites such as RedFlagDeals.com™, CouponCabin.com™, RetailMeNot.com™, among others. Several shopping blogs also exist such as SmartCanucks.com™ which act as both a deal website and a commentary on the latest trends in fashion and electronics, etc. These sites require users to visit their sites on a regular basis to keep up with available sales, promotions and products, while other users may post interesting sales and deals in the forums of these sites. Through partnerships, companies may post up specific sales. There's no guarantee on these sites that an available promotion the consumer is looking at is actually listed since it is based on discretion of the content managers, or blog owners, of these sites to post whatever content they find interesting. Other companies like Flyerland.com provide electronic versions of flyers on their website to provide access for consumers in one place. However, not all companies use flyers due to the costs involved, while Flyerland.com™ simply changes the format of the flyer and does not solve the actual relevancy issue related to advertisements addressed herein.

The lack of organization of sales promotional information is compounded by a plethora of social media pages for retailers including Facebook™ pages, Facebook™ groups and Twitter™ pages. This requires that consumers essentially add all of these retailers individually so they keep up with the latest promotions from their favorite stores. Even if a consumer is able to follow all of these retailers, the nature of Facebook™ or Twitter™ as status-based websites ensures that it is nearly impossible for consumers to receive every message. A consumer may have 500+ friends and 1000+ followers on Facebook™ and Twitter™, respectively, and they all contribute to the information on an individual's News Feed; this ensures that any news item posted by a retailer on a Facebook™ page or Twitter™ page will get bumped to the next page of the user's News Feed within minutes or even seconds. As a result, the current model for sales distribution on existing social media sites is inefficient given the extra “noise,” or non-sales related information, that exists.

The significant amount of sales promotional information on these sites combined with promotions made available to a consumer via flyers and newspaper, magazine, radio and television advertisements leads to an overabundance of sales promotional information. This makes it difficult for a consumer to find relevant information on items (products and/or services) that meet their immediate purchase interests. Even with recommendations using social networks, it is difficult to find peers who are interested in particular information as immediate purchase interests are not known. As a result, social recommendations may also be improved by defining a user's current shopping preferences.

An organized portal for sales information online is required where merchants are in control of their advertisements and are able to connect with consumers interested in their products and services. The sales system must fulfill the following requirements: 1) merchants are able to post their sales information and remain in control of their branding, and 2) consumers should receive, with 100% certainty, relevant sales information on products and services that they seek. Consumers are able to perform location-based searches, find specific products and services of interest, and attain feedback from other consumers about the sales experiences at these merchants prior to making a purchase. In addition, following a permission marketing strategy, consumers opt into receiving updates from preferred merchants. They are able to add or remove items that they are seeking, edit the search range or location, or turn the delivery system on or off entirely. They are also able to change the frequency with which updates are delivered to them real-time. In essence, what is missing is the opposite of search, or a “reverse search”, to push sales information from the system to consumers that are currently seeking this information, without spam. A change in philosophy in how sales information is delivered to consumers is crucial to improving response rates of advertisers.

### Merchant Visibility

A few online solutions exist that provide merchants with increased visibility online such as Google Places™ and Yellow Pages™, among others. These sites improve the merchant's online visibility such as with Search Engine Marketing (SEM) using the Google AdWords™ platform, which targets user queries on search engines with advertisements. Another approach used to increase merchant visibility online is Search Engine Optimization (SEO), an inbound marketing strategy which aims to increase a merchant's ranking in search results through more targeted key words and link building. Merchants with a higher ranking are more likely to have their linked clicked on by the user resulting in a greater number of leads.

These sites also provide a merchant storefront where users can view the merchant's page online, which is essentially the landing page for a search query using either SEM or SEO. Google™ has integrated Google Places™ with their search engine so that users can find products and services of merchants in their search results, while the storefront is also available on their Maps platform when a user searches for a particular location on Google Maps™. Yellow Pages™ uses the storefront as a page where users can view more information about a business. However, as advertisers become more familiar with these platforms and what key words to use, the relevancy of search results to a user search decreases. As a result, a system is required that guarantees that merchant sales promotional information is delivered with 100% certainty to consumers looking for that information at that point in time based on user-defined preferences, geolocation, and user-granted permission, which the Google AdWords™, Google Places™ and Yellow Pages™ platforms do not currently provide. Consumers seek content and they want to be connected with merchants selling what they need at a competitive price.

### Product/Service Suggestions

Websites for online sales such as Amazon™ and eBay™ display product suggestions by providing related products and searches (also referred to as “relevant search results”) to a browsing user based on, for example, matching search history, history of product purchases, product categories and/or relevance by the location information of the user. Other websites such as GroupOn™ use suggestions between peers on social networks by creating a significantly discounted deal offered by a merchant of 50-90% off products and services, which does not become active until a minimum number of users have opted into the deal. However, direct recommendations of advertising content between specific members of a social circle are not performed, though GroupOn™ uses Facebook™ and Twitter™ to share awareness of group deals to a user's social circle through the News Feed.

The underlying success of sales is heavily linked to the necessity for a social recommendation and word-of-mouth between members of a social community. These direct friend-to-friend recommendations provide positive reinforcement for a business's products and services based on successful experiences of a consumer's peers. This friend-to-friend recommendation is the basis of spreading awareness of trustworthy brands and products and plays heavily into a consumer's decision process and the value that they place on a merchant, and ultimately impacts the final consummation of a sale. These friend-to-friend recommendations are marketing initiatives that rely on trust in social relationships to bring merchants and consumers together through better awareness. These recommendations lead to more efficient distribution of trusted ad content to a consumer as members of a social circle often discuss good and bad sales experiences.

A solution is required that allows users to send directed recommendations to specific individuals in their social circle based on products and services that they may be interested in, with increased relevance to the receiving user of the recommendation. This requires a social media application for a commerce network that facilitates sharing. These sale recommendations are significant as friends often share the same interests and often discuss products and services that they may be interested in purchasing or have purchased. Directed sales recommendations are more suitable than news feeds, or product suggestion widgets, as they contain a one-to-one message between friends and allow friends to inform one another of sale promotional information that may exist only for a limited time.

### SUMMARY

A computer-implemented method that consolidates description information and inventory information associated with an advertisement for the organization of advertisement information of one or more merchants in a commerce network for access by one or more consumers, the method comprising:

displaying description information of one or more advertisements in the form of text, images, ad creative art or video on the consumer's screen for the purpose of disclosing the contents of the advertisements to one or more consumers over one or more telecommunication services; and

attaching inventory information to the advertisement in the form of one or more products or services offered by the merchant in association with the advertisement.

The method of claim 1 further comprising attaching quantity information related to inventory information available for purchase in association with the advertisement.

The method of claim 1 further comprising attaching price information related to inventory information available for purchase in association with the advertisement.

The method of claim 1 further comprising attaching merchant information in the form of name information and logo creative content associated with the advertisement.

The method of claim 4 further comprising attaching merchant reputation information in the form of an average merchant rating submitted by one or more consumers.

The method of claim 4 furthering comprising attaching merchant geolocation information in the form of

country, city, address, zip/postal code, and latitude and longitude coordinate information associated with one or more participating merchant locations at which the advertisement information is applicable.

The method of claim 6 further comprising sorting one or more participating merchant locations in association with the advertisement by geolocation information in the form of the distance of one or more participating locations to the consumer's geolocation represented by the position of a user client device at the time of the sort.

The method of claim 1 further comprising retrieving, aggregating and publishing purchase information of one or more consumers related to inventory information associated with the advertisement.

The method of claim 4 further comprising retrieving, aggregating and publishing review information of one or more consumers related to merchant information associated with the advertisement.

The method of claim 7 further comprising retrieving, aggregating and publishing location-based activity based on geolocation such as presence announcements by consumers using one or more user client devices at a sales event at one or more participating merchant locations associated with the advertisement.

The method of claim 1 wherein new consolidated advertisement information that is posted in one or more ad servers of the commerce network is indexed by the correlation between word patterns using natural language processing by latent semantic analysis to determine the context of words specified within advertisement information, the method comprising:

counting word occurrences in the description information and inventory information associated with the consolidated advertisement information where words in a stop-word list that do not affect meaning are excluded from the tally;

storing or updating the counting data of word occurrences in a word by advertisement matrix A;

performing singular value decomposition on matrix A to determine three component sub-matrices: the word matrix U_{A}, the eigenvalue matrix S_{A}, and the advertisement matrix V_{A}^{T}; and

choosing one or more top eigenvalues in S_{A} to emphasize the strongest word relationships in the consolidated advertisements and remove noise in U_{A} and V_{A}^{T} via dimension reductionality.

The method of claim 11 further comprising the plotting of the coordinates of each word in the U_{A} matrix and each advertisement in the V_{A}^{T} matrix on a coordination plane to create “concepts,” or clusters that group words and advertisements by category based on the strength in word relationships.

The method of claim 1 wherein advertisement information is displayed in the form of search results in response to a user search query for advertisement information, the method comprising:

receiving, from the system, the user search query consisting of one or more keywords;

retrieving, from the system, the matrix V_{A}^{T} that contains the coordinates of the advertisements on the coordinate plane;

mapping the user search query into a document Q for comparison against the advertisements on the coordinate plane by finding Q=qₜU_{A}S_{A}⁻¹, where qₜ maps the keywords of the user search query using a “1” for each keyword in U_{A} that exists in the user search query and a “0” for each keyword in U_{A} that does not exist in the user search query;

retrieving the coordinates of the user search query X stored in Q;

determining the cosine similarity between the coordinates of the user search query X and the coordinates of each advertisement Y in V_{A}^{T} as cos Θ=X·Y/(|X∥Y|), where X·Y is the dot product between the two coordinate vectors and |·| represents the magnitude of the vector, and the smaller the angle Θ between X and Y (i.e., as approaches zero), the more similar an advertisement information is to the keywords in the user search query (i.e., cos Θ approaches one);

ranking advertisements in order of cosine similarity to the keywords in the user search query and denote those advertisements as user search results; and

delivering user search results to the user.

The method of claim 13 wherein one or more user search results are displayed in tile, list or full page format for the display of consolidated advertisement information.

The method of claim 1 wherein advertisement information is interactive whereby embedded description, inventory, quantity, price, merchant, merchant reputation, geolocation, purchase, review and location-based activity information are accessed or clicked through by hyperlinks, tag keywords, word clouds, bar codes or Quick Response (QR) codes displayed as part of the advertisement on a consumer screen.

The use of the method of claim 1 wherein the commerce network is a social network with consumers and merchants acting as members, the use comprising:

retrieving, for the purpose of using social relationships, social graph information of one or more consumers from either the system or third party social network application programming interface;

determining the degree of separation between two members of the social network based on the minimum number of intermediate member relationships between the respective members;

retrieving the members within a predetermined degree of separation from a given member of the social network;

delivering a sales-tag of an advertisement including a personal message in text, image or video format from one member to another member within one degree of separation of the recommending member;

providing payment solutions over one or more telecommunications services for the purchase of products and services available in limited quantities in association with the advertisement;

consolidating quantity information, geolocation information and inventory information to determine one or more participating locations in association with an advertisement at which one or more products and services added by a consumer to a shopping cart are available with quantity in stock;

aggregating purchase information related to inventory information associated with an advertisement of one or more members and publishing the aggregated purchase information in association with the advertisement;

aggregating review information related to merchant information associated with an advertisement of one or more members and publishing the aggregated review information; or

aggregating location-based activity based on geolocation such as presence announcements by members using one or more user client devices at a sales event at one or more participating merchant locations associated with an advertisement.

The use of the method of claim 1 wherein the commerce network is a telecommunications network such as a mobile network with consumers and merchants acting as members and accessing the advertising network through one or more telecommunication services, the method comprising:

retrieving, for the purpose of using social relationships, social graph information of one or more consumers from either the system or third party social network application programming interface;

maintaining a graph of relationships between one or more consumers and one or more merchants through member identifiers and approved connections by the system;

determining the degree of separation between two members of the social network based on the minimum number of intermediate member relationships between the respective members;

retrieving the members within a predetermined degree of separation from a given member of the social network;

delivering a sales-tag of an advertisement including a personal message in text, image or video format from one member to another member within one degree of separation of the recommending member;

providing payment solutions over one or more telecommunications services for the purchase of products and services available in limited quantities in association with the advertisement;

consolidating quantity information, geolocation information and inventory information to determine one or more participating locations in association with an advertisement at which one or more products and services added by a consumer to a shopping cart are available with quantity in stock;

aggregating purchase information related to inventory information associated with an advertisement of one or more members and publishing the aggregated purchase information in association with the advertisement;

aggregating review information related to merchant information associated with an advertisement of one or more members and publishing the aggregated review information; or

aggregating location-based activity based on geolocation such as presence announcements by members using one or more user client devices at a sales event at one or more participating merchant locations associated with an advertisement.

A computer-implemented method for the delivery of relevant advertisement information to a consumer, the method comprising the consumer specifying one or more merchant identifiers in preference filter information for the purpose of receiving advertisements from one or more merchants of interest in a commerce network.

The method of claim 18 further comprising the consumer specifying one or more merchant location identifiers in preference filter information for the purpose of receiving advertisements from one or more merchant locations of interest in the commerce network.

The method of claim 18 further comprising the consumer specifying one or more regions in preference filter information for the purpose of receiving advertisements from one or more specific geographical areas of interest in the commerce network.

The method of claim 18 further comprising the consumer specifying one or more keywords in preference filter information for the purpose of receiving advertisements related to products or services of interest defined by the specified keywords in the commerce network.

The method of claims 18 and 21 further comprising the consumer attaching geolocation targeting information to one or more merchant identifiers or keywords specified in preference filter information to narrow the search for relevant advertisements.

The method of claim 18 further comprising the consumer specifying permission information in the preference filter information to turn the delivery of preference filter search results on and off at will to improve the time relevancy of received advertisement information to the consumer.

The method of claim 18 wherein new preference filter information that is added or updated in the commerce network is indexed by the correlation between word patterns using natural language processing by latent semantic analysis, the method comprising:

counting keyword occurrences in the new preference filter information where keywords in a stop-word list that do not affect meaning are excluded from the tally;

storing or updating the counting data of keyword occurrences in a word by preference filter matrix P;

performing singular value decomposition on matrix P to determine three component sub-matrices: the word matrix U_{P}, the eigenvalue matrix S_{P}, and the preference filter matrix V_{P}^{T}; and

choosing one or more top eigenvalues in S_{P} to emphasize the strongest word relationships in the preference filter information and remove noise in U_{P} and V_{P}^{T} via dimension reductionality.

The method of claim 24 further comprising plotting of the coordinates of each keyword in the U_{P} matrix and each preference filter in the V_{P}^{T} matrix on the coordination plane to determine the similarity of preference filters to existing “concepts,” or clusters that group keywords and preference filter information by category based on the strength in keyword relationships.

The method of claim 18 wherein a search is performed by the system to deliver preference filter search results whenever new preference filter information is added or updated in the commerce network, the method comprising:

retrieving, from the system, the coordinates of the new preference filter information X determined via indexing of the new preference filter information;

retrieving, from the system, the advertisement matrix V_{A}^{T};

determining the cosine similarity between the coordinates of the new preference filter keyword mapping X and the coordinates of each advertisement Y in V_{A}^{T} as cos Θ=X·Y/(|X∥Y|), where X·Y is the dot product between the two coordinate vectors and |·| represents the magnitude of the vector, and the smaller the angle Θ between X and Y (i.e., as Θ approaches zero), the more similar an advertisement information is to the keywords in the new preference filter information (i.e., cos Θ approaches one);

accepting those advertisements that satisfy a predetermined threshold for similarity necessary for the delivery of advertisement information;

ranking advertisements in order of cosine similarity to preference filter keywords from highest to lowest;

denoting the accepted advertisements as preference filter search results; and

delivering preference filter search results to the user.

The method of claim 26 further comprising:

retrieving advertisement information V_{A}^{T} in matrix form associated with one or more merchants specified in the new preference filter information;

denoting the advertisement information as preference filter search results; and delivering preference filter search results to the user.

The method of claims 26 and 27 further comprising, after retrieving the advertisement matrix V_{A}^{T}, the step of retrieving the subset of advertisements V_{A}^{T}* which have participating locations within regions set, if any, in the consumer's preference filter information for processing.

The method of claim 26 further comprising:

retrieving advertisement information associated with one or more merchant locations specified in the new preference filter information;

denoting the advertisement information as preference filter search results; and

delivering preference filter search results to the user.

The method of claim 18 wherein a search is performed by the system to deliver preference filter search results whenever new advertisement information is posted in one or more ad servers of the commerce network, the method comprising:

retrieving, from the system, the coordinates of the new advertisement information Y determined via indexing of the new advertisement information;

retrieving, from the system, the preference filter matrix V_{P}^{T};

retrieving the subset of consumer preference filters V_{P}^{T}* by analytical means;

determining the cosine similarity between the coordinates of the each preference filter mapping X in V_{P}^{T}* and the coordinates of the new advertisement information Y as cos Θ=X·Y/(|X∥Y|), where X·Y is the dot product between the two coordinate vectors and |·| represents the magnitude of the vector, and the smaller the angle Θ between X and Y (i.e., as Θ approaches zero), the more similar the new advertisement information is to the keywords in the preference filter information (i.e., cos Θ approaches one);

accepting those consumer preference filters for which the new advertisement information satisfies the predetermined threshold for similarity necessary for the delivery of advertisement information;

denoting the advertisement as a preference filter search result for those accepted consumer preference filters; and

delivering the preference filter search result to the users associated with the accepted consumer preference filters.

The method of the methods of claims 26, 27, 29 and 30 further comprising:

delivering preference filter search results to one or more user device clients associated with the consumer information; and

notifying consumers on one or more user clients of new preference filter search results.

The method of claim 30 wherein the analytical means is selected from the group consisting of consumer preference filters that have specified the merchant, one or more merchant locations that are specified as participating merchant locations in association with the advertisement, and one or more regions in which the merchant has participating locations in association with the advertisement.

The method of claims 26 and 30 wherein the basis for sorting of the preference filter search results is selected from the group consisting of:

price information related to inventory information associated with the preference filter search results in ascending or descending order;

geolocation information in terms of the distance from the consumer's geolocation represented by the position of a user client device at the time of the search to the geolocations of one or more participating merchant locations associated with the advertisement in ascending or descending order;

quantity information, if applicable, in terms of remaining units of inventory associated with the preference filter search results available for purchase in ascending or descending order;

merchant reputation information in terms of the average merchant rating associated with the preference filter search results in ascending or descending order; and

time posted for advertisements associated with preference filter search results by most recently posted or latest posted.

The method of claims 26 and 30 wherein the purchase information related to inventory information associated with a preference filter search result of one or more members is aggregated and published in association with the preference filter search result.

The method of claims 26 and 30 wherein the review information related to merchant information associated with a preference filter search result by one or more members is aggregated and published in association with the preference filter search result.

The method of claims 26 and 30 wherein the location-based activity based on geolocation such as presence announcements by members using one or more user client devices at a sales event at one or more participating merchant locations associated with a preference filter search result is aggregated and published in association with the preference filter search result.

The method of claim 18 wherein sales-tagging further delivers relevant advertising information between members of the commerce network, the method comprising:

receiving, from a member, a sales-tagging request including the associated advertisement identifier, and one or more member identifiers to whom the recommending member is requesting the recommendation be sent to;

accepting the sales-tagging request, after verifying the recommending member is valid, and storing the recommendation in the system; and

transmitting the recommendation in the form of the associated advertisement information to one or more user client devices associated with the accounts of the receiving members of the recommendation.

The method of claim 37 further comprising:

receiving a personal message in the form of text, images or video in association with the sales-tagging request to be sent with the recommendation to one or more member identifiers to whom the recommending member is requesting a recommendation be sent to; and

transmitting the personal message in association with the sales-tag of an advertisement to one or more user client devices associated with the accounts of the receiving members of the recommendation.

The method of claim 37 further comprising adding a system-generated personal message to the recommendation, stating the nature of the recommendation if one is not provided by the recommending member as part of the sales-tagging request.

The method of claim 37 further comprising delivering a notification to receiving members of the sales-tag on one or more user client devices associated with the accounts of those members.

The method of claim 18 further comprising aggregating keywords of preference filter information of one or more consumers and displaying the aggregated keywords for view by one or more merchants of the commerce network to inform them of products and services that consumers are seeking at that point in time, the method comprising:

retrieving, from the system, the preference filter matrix V_{P}^{T} and the advertisement matrix V_{A}^{T} that contain the coordinates of the consumer preference filters and the advertisement information on the coordinate plane, respectively;

determining the consumer preference filters that lie within a predetermined cosine similarity range to one or more advertisements posted by a merchant;

enumerating the keywords of the identified consumer preference filters for the purposes of determining the word occurrences in one or more of the identified consumer preference filter information stored in the system here words in a stop-word list that do not affect meaning are excluded from the tally; and

displaying the enumerated top word occurrences for view by one or more merchants of the commerce network.

A computer-implemented method for the rendering of a location-based advertisement that is used by nearby merchants to provide incentives to the consumer to purchase one or more products or services of the merchant, the method comprising:

displaying description information associated with the location-based advertisement in the form of text, images, ad creative art or video on the consumer's screen; and

attaching merchant information in the form of merchant geolocation information associated with the location-based advertisement to display the distance of the merchant from the consumer's geolocation at the time of rendering the location-based advertisement.

The system of claim 42 further comprising prompting a consumer for permission on one or more client devices over one or more telecommunications services in the form of a rectangular permission prompt with two buttons, labelled “View” and “Dismiss,” prior to displaying an impression of the location-based advertisement.

The method of claim 43 further comprising embedding the permission-prompt with a predetermined time-out value such that, if the permission-prompt is displayed for the duration of the time-out value, the advertisement expires and disappears.

The method of claim 42 further comprising attaching inventory information of one or more products or services offered by the merchant for purchase in association with the location-based advertisement.

The method of claim 42 further comprising attaching price information of one or more products or services offered by the merchant for purchase in association with the location-based advertisement.

The method of claim 42 further comprising attaching merchant reputation information in the form of rating information by one or more consumers who have rated the merchant.

The method of claim 42 further comprising the location-based advertisement information adhering to the preference filter information set by the consumer prior to displaying a location-based advertisement from the merchant on one or more consumer screens.

The method of claim 42 further comprising using the consumer's geolocation to ensure that the consumer is within a valid operating region of a merchant prior to displaying a location-based advertisement from the merchant on one or more consumer screens.

The method of claim 49 further comprising defining the valid operating region of the merchant as based on maximum range information associated with the merchant information extending outwards in all directions from the merchant's geolocation, thereby creating a circular area as the valid operating region.

### BRIEF DESCRIPTION OF DRAWINGS

FIG. 1 illustrates a high-level view of the entities that interact with the commerce network.

FIG. 2 presents the environment in which the commerce network operates and the interaction with both merchants and consumers.

FIG. 3 depicts system components with which the commerce network operates.

FIG. 4 is a bubble diagram illustrating the important components of the preference filter system in identifying relevant consumers upon entry or modification of advertisement information by a merchant.

FIG. 5 illustrates exemplary relevant user request information that is consistent with the present invention.

FIG. 6 illustrates exemplary advertisement information that is consistent with the present invention.

FIG. 7 illustrates exemplary inventory information that is consistent with the present invention.

FIG. 8 illustrates exemplary product/service information that is consistent with the present invention.

FIG. 9 illustrates exemplary merchant information that is consistent with the present invention.

FIG. 10 illustrates exemplary merchant location information that is consistent with the present invention.

FIG. 11 illustrates exemplary merchant reputation information that is consistent with the present invention.

FIG. 12 illustrates exemplary ad statistical information consistent with the present invention.

FIG. 13 illustrates exemplary user information that is consistent with the present invention.

FIG. 14 illustrates exemplary preference filter information that is consistent with the present invention.

FIG. 15 is a flow diagram of an exemplary method for advertisement information entry and modification.

FIG. 16 is a flow diagram of an exemplary method for carrying out a relevant user identification request upon entry or modification of advertisement information by a merchant.

FIG. 17 depicts a coordinate plane that illustrates the indexing of advertisement information and preference filter information by keyword relationships into one or more keyword groupings or categories according to one embodiment of the present invention.

FIG. 18 is a flow diagram of an exemplary method for preference filter information entry and modification.

FIG. 19 illustrates a screenshot of a consumer screen for the entry of preference filter information according to one embodiment of the present invention.

FIG. 20 is a flow diagram of an exemplary method for delivering new advertisement information and notifications to one or more relevant consumers on one or more user clients according to one embodiment of the present invention.

FIG. 21 illustrates a screenshot of a consumer screen of a sample query and preference filter search results generated using advertisement information and preference filter information from the commerce network according to one embodiment of the present invention.

FIG. 22 is a bubble diagram illustrating the important components of the preference filter system in identifying relevant advertisement information upon entry or modification of preference filter information by a consumer.

FIG. 23 illustrates exemplary preference filter request information that is consistent with the present invention.

FIG. 24 is a flow diagram of an exemplary method for carrying out a preference filter advertisement selection request upon entry or modification of preference filter information by a consumer.

FIG. 25 is a flow diagram of an exemplary method for delivering advertisement information and notifications to one or more relevant consumers on one or more user clients based on new preference filter information according to one embodiment of the present invention.

FIG. 26 is a bubble diagram illustrating the important components of the location-based advertisement system based on user-granted permission.

FIG. 27 illustrates exemplary location-based advertisement request information that is consistent with the present invention.

FIG. 28 illustrates exemplary location-based advertisement information that is consistent with the present invention.

FIG. 29 is a flow diagram of an exemplary method for carrying out a location-based advertisement selection request based on geolocation targeting information and consumer preference filter information according to one embodiment of the present invention.

FIG. 30 is a flow diagram of an exemplary method for location-based advertisement entry and modification.

FIG. 31 is a flow diagram of an exemplary method for the delivery of a location-based advertisement impression based on user-granted permission.

FIG. 32 is a screenshot of a consumer screen illustrating a display of a permission prompt to the consumer with two buttons, labeled “View” and “Dismiss,” prior to the display of a location-based advertisement impression according to one embodiment of the present invention.

FIG. 33 is a screenshot of a consumer screen illustrating a display of a location-based advertisement impression upon being granted user permission according to one embodiment of the present invention.

FIG. 34 is a bubble diagram illustrating the operation of a sales-tag in a social network for the propagation of relevant sales promotional information.

FIG. 35 illustrates exemplary sales-tagging request information consistent with the present invention.

FIG. 36 is a flow diagram of an exemplary method for sales-tag delivery in a social network to peers within one degree of separation according to one embodiment of the present invention.

FIG. 37 is a block diagram of an exemplary apparatus that may perform various operations in a manner consistent with the present invention.

### DETAILED DESCRIPTION

The present invention may comprise methods, database structures and message formats for the delivery of relevant advertisement content in a commerce network. The following description is presented such that an expert in the field can discern and use the present invention, and is provided in the context of particular applications and their requirements. Various modifications to the disclosed embodiments will be evident to an expert in the field, and the general principles set forth below may be applied to other embodiments and applications. Thus, the present invention is not intended to be limited to the embodiments shown and the inventors regard their invention as any patentable subject matter described.

This section will describe environments in which, or with which, the present invention may operate as described in Section 5.1. In Section 5.2, exemplary embodiments of the present invention will be described. Finally, some conclusions regarding the present invention are set forth in Section 5.3.

### Environments

### Exemplary Commerce Environment

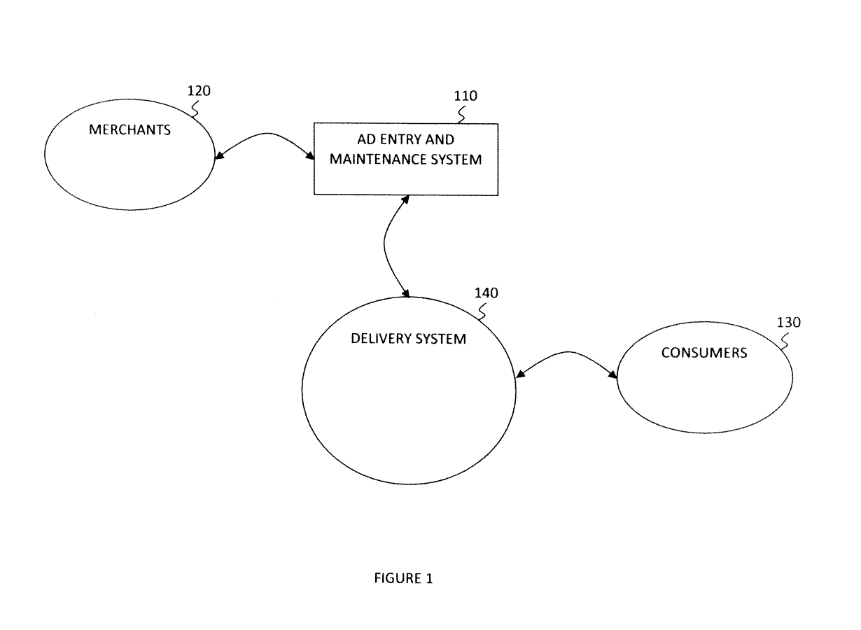

FIG. 1 presents a high-level view of the commerce environment in a social media context. The environment consists of an ad entry and maintenance system 110, merchants 120, consumers 130 and a delivery system 140. Merchants 120 may directly, or indirectly, maintain advertisement content at the ad entry and maintenance system 110. An advertisement may consist of graphics, video, audio, text or a combination of these components. Advertisements may also include embedded information such as links, trackers and executable information. Advertisements may also include identification information such as UPC barcodes, Quick Response (QR) codes, etc. for ease of redemption by one or more users directly from the ad creative content. In the advertising environment depicted herein, Advertisements may also include expiry information, category information, type of sale information, geolocation targeting information, inventory information for one or more products/services being promoted by the merchant in conjunction with the advertisement, etc. A consumer 130 may submit requests for advertisements or another entity other than a consumer 130 may initiate the request for advertisements. A consumer 130 may accept advertisements in accordance with the request and may submit feedback data to the system regarding click-through and conversion rate information.

The ad entry and maintenance system 110 maintains the advertisement campaigns of several merchants 120 for a number of advertisements types including in store advertisements or promotions, web-only advertisements and location-based mobile advertisements on consumer handheld devices. The system does so by maintaining accounts per merchant for the management of multiple advertisement campaigns for multiple merchant locations. An “account” relates to information per merchant and may include username, email address, contact information, billing information, one or more merchant geolocations for multiple store locations and inventory information. An “advertisement campaign” may refer to one or more advertisements and may include one or more ad creatives, one or more click-through links or universal resource locators (URLs), one or more start and expiry dates, one or more applicable merchant locations associated with the advertisement campaign, billing information, etc. For example, Starbucks, with several merchant locations, may create one advertisement campaign for merchant locations in Los Angeles and a different advertisement campaign for merchant locations in San Francisco, both advertisement campaigns maintained through the same merchant account.

A consumer 130 may receive ads for an advertisement campaign from the ad entry and maintenance system 110 through a delivery system 140. The delivery system 140 identifies a consumer 130 through user information. User information maintains a profile of a consumer 130 including name, numeric identifier, email address, handle, username, area code, telephone number, one or more numeric identifiers of peers to identify social relationships, one or more user client device identifiers, one or more user client social profile identifiers, geolocation information, preference filter information, etc. User information of a consumer 130 includes one or more peer identifiers for the purpose of forming a social graph of connectivity of consumers 130 to identify social relationships between consumers 130. The ad entry and maintenance system 110 and the delivery system 140 may exist as one ad entry, modification and delivery system or as separate entities as they are shown as FIG. 1.

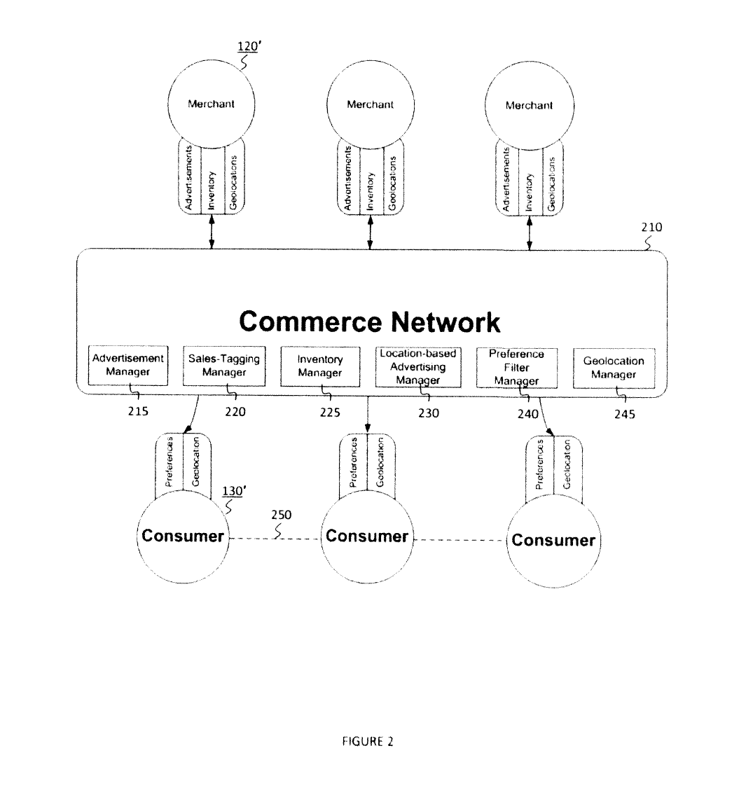

FIG. 2 presents the environment in which the commerce network 210 may operate where the commerce network 210 interacts with both merchants 120′ and consumers 130′. Merchants 120′ are defined primarily by their advertisements, available inventory and geolocations of one or more merchant locations associated with the merchant account. Consumers 130′, on the other hand, are defined primarily by their immediate purchase preferences and their geolocations. However, they are also defined by their social relationships 250 that represent their immediate connections with other consumers 130′, or more technically defined as the users within one degree of separation from the user in question in a social graph of connectivity. The commerce network itself is formed of one or more managers that form the basis of the system that connects relevant merchants with relevant consumers. These managers include the advertisement manager 215, which handles the consolidation of advertisement information by: description information to disclose the contents of the advertisement or promotion; merchant information including location names and the merchant's reputation to help consumers find reputable merchants; inventory information to explicitly inform consumers of the products and services available in accordance with the advertisement; price information associated with inventory information; quantity information associated with the inventory information; and, geolocation information to both provide location information for one or more merchant locations at which the advertisement applies, and link the inventory, quantity and price information to one or more merchant locations to improve product based search by location. The sales-tagging manager 220 is responsible for delivering recommendations between consumers 130′ of the commerce network 210′ such that consumers 130′ are more easily able to inform friends about sales information that they may find useful. The inventory manager 225 handles the updating of available products and services, price information and quantity information at the merchants 120′. The delivery of location-based advertisements is carried out by the location-based advertising manager 230 that uses a permission-marketing strategy to prompt the user for permission to display a relevant location-based advertisement from a nearby merchant related to products and services of interest. This user-granted permission strategy helps to manage information overload of sales information by putting consumers 130′ in control of the sales information that they consume. The setting and maintenance of real-time user preferences is performed by the preference filter manager 240 that receives input from the consumer 130′ regarding: merchants of interest, specific merchant locations of interest, regions of interest from which a consumer is willing to receive advertisement information from, and keywords set by the consumer 130′ related to products and services of interest. The preference filter manager 240 is also responsible for delivering content to the user based on these set preferences that the user can turn on and off at any time based on need or interest. The responsibilities of the preference filter manager 240 are crucial to solving the relevancy issues surrounding advertising and current sales information distribution by only delivering content that the consumer 130′ is interested in purchasing at the current time. The geolocation manager 245 maintains the positions of online consumers 130′ in the commerce network 210′ in relation to one or more merchant locations and ensures that merchants 120′ adhere to the geographic restrictions of advertising set in consumer's preference filter information.

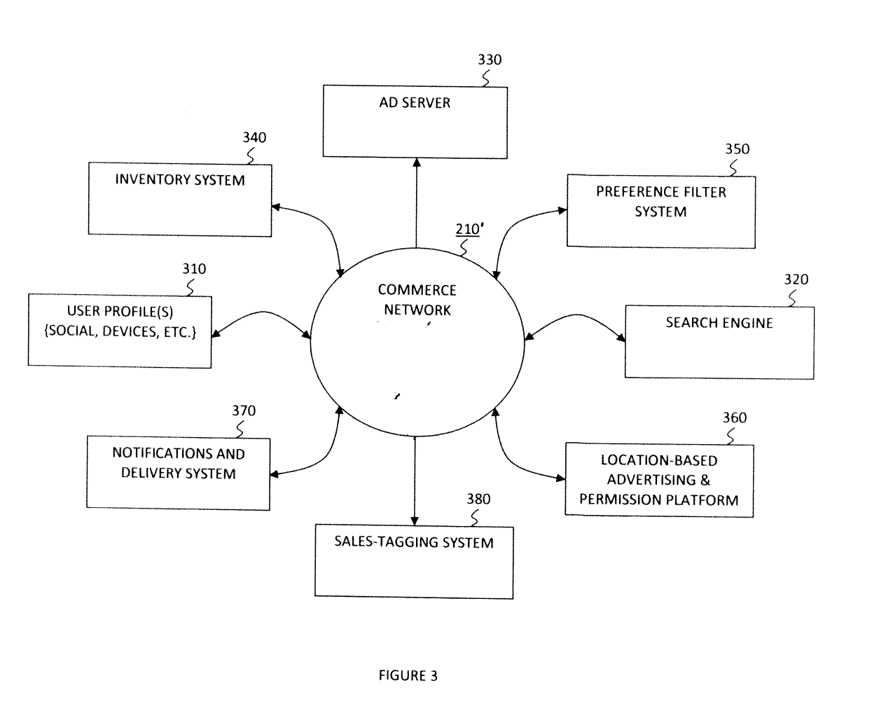

FIG. 3 depicts the system components with which the commerce network 210′ may operate. A user client relates to a desired integration point (e.g., a user client device, social profile such as a Facebook™ account, web browser, application on user client device, etc.) in accessing the commerce network 210′ and is represented by user profile(s) 310. User profile(s) 310 may include, or access, a browsing facility (such as the Safari browser from Apple™, Chrome browser from Google™, Internet Explorer browser by Microsoft™, etc.) to access the commerce network 210′ that may exist as a mobile application (such as on the Apple iPhone/iPad™ platform, Google Android™ platform, etc.), a social network application (such as on the Facebook™ platform, Twitter™ platform, etc.) or standalone website. A search engine 320 may be used by a user client to submit a request for advertisements from the ad server 330 (i.e. advertisements relating to clothing, flights, food, electronics, etc.) and related inventory 340. A preference filter 350 may also be set to do an automatic search of the ad server 330 and automatically deliver advertisement content to one or more user profile(s) 310 whenever a new advertisement is entered into the ad server 330 that matches one or more preference filter 350 terms set by the user to indicate current shopping preferences.

Location-based advertisements may also be delivered to a user profile using a location-based advertising & permission platform 360, in which a user client is shown a permission prompt prior to serving an advertisement from the ad server 330. Location-based advertisement selection may use the geolocation information associated with one or more user profile(s) 310, geolocation information of the merchant, preference filter information 350 associated with the user information and the geolocation targeting information associated with a location-based advertisement, i.e. a maximum range associated with a location-based advertisement to be delivered to a user profile 310 if the user client is within range of the merchant's geolocation. The location-based advertisement from the ad server 330 may only be delivered to a user client upon acceptance by the user at the permission prompt. The goal of the permission prompt is to give more control to users of the advertisement content that they consume.

Still referring to FIG. 3, a notifications and delivery system 370 may be used by the commerce network 210′ to inform a user of: a sales tag from one of their peers arriving from a sales-tagging system 380, a new advertisement that has been added to the ad server 330 that matches the preference filter set by the user; or an offer by one or more merchants based on products and services specified in the user's preference filter information. The sales-tagging system 380 extends awareness through social networks of advertisements by rewarding trusted and reputable merchants.

### DEFINITIONS

A “user” (also known as a “consumer” or “member”) is any entity accessing the commerce network for the purpose of browsing the commerce network for ad content.

An “advertiser” (also known as a “merchant”) is any corporate entity using the commerce network for commercial purposes such as advertising or sales promotional distribution.

“Interruption advertising” is the current method of advertising whereby consumers do not have control of the advertising information they consume, but rather are forced to consume it at any time over any number of media streams.

“Permission marketing” is a change in advertising philosophy in which consumers are given the choice of the advertisements that they consume. In the commerce network addressed herein, consumers are prompted for permission prior to the rendering an advertisement.

A “commerce network” is defined as a repository for consolidated advertisement information based on inventory information and geolocation information, and connects relevant merchants and consumers to improve sales distribution.

An “advertisement” (also known as “promotion” or “sales promotional information”) is defined as a marketing initiative by a merchant to attract consumers to their establishment, products and/or services. A merchant's advertisement may be maintained by the merchant itself, the owners of the commerce network or one or more third party agencies operating on the merchant's behalf. In the commerce network addressed herein, advertisement information is leveraged with associated inventory and geolocation information to provide a location-aware system for the sale of goods and services to consumers.

An “impression” of an advertisement is defined as a physical display of a single advertisement on a website.

A “social network” is defined as any Internet community that may identify users by numeric identifiers, names, handles, usernames, email addresses, area codes, telephone numbers, etc. and forms a social graph of connectivity of its users in a computer system to identify social relationships. In the commerce network addressed herein, the utilization of the social network enables for members of the social network to share relevant advertisement content in the commerce network with their peers.

A “social graph” is a computer-implemented system that may be used to maintain a data structure (e.g., tree, table, etc.) to maintain the connectivity of two or more users identified by user identifiers in a social network to represent social relationships. All users connected to a single individual in a social graph are referred to as friends, followers, or peers within one degree of separation of the individual.

“Degree of separation” is a social network term that defines the relatedness between two or more members of a social network in the form of the minimum count of the intermediate members between the two individuals in the social graph.

“Geolocation information” may include, in one embodiment, one or more countries, one or more regions, one or more states/provinces, one or more cities/towns/municipalities/neighborhoods/localities, one or more zip/postal codes, one or more addresses, one or more telephone area codes, and one or more telephone numbers, to define the positioning of a consumer or merchant. In another embodiment, it may include latitude and longitude coordinates of the consumer or merchant. In another embodiment, it may include the IP address to determine the locations of the consumer or merchant.

“Geolocation targeting information” (or “region”) may include location information to determine one or more operating areas associated with a request. In one embodiment, geolocation targeting information may include distance threshold information by defining a range extending outwards in all directions from a central point of interest (e.g. a merchant's geolocation) thereby defining a circular area as a valid operating region such as for the delivery of a location-based advertisement. In a second embodiment, it may include one or more regions defined by country, city/town/municipality/neighborhood/locality, zip/postal code, telephone area code, or specific ranges of latitude and longitude coordinates to add location information to a search or preference filter information. For example, a user may attach geolocation targeting information to a search to restrict search results to only downtown San Francisco, Calif., or their neighborhood Wellington Village, Ottawa.

“Inventory information” may include information relating to one or more products or services offered by a merchant. This product/service information may include product/service identifiers, price information and quantity information at one or more merchant locations defined by geolocation information. It is used to organize the sales information of local merchants for ease of integration with the commerce network and enable consumers to perform price comparisons for specific products/services by locality.

“Item” (also known as “product” or “service”) may include any offering made available for purchase by a merchant.

“Category information” may include product/service categories such as travel, computer and electronics, food, home and garden, students, fashion, etc. for the organization of advertisement content on the advertisement server, ease of searching by users, and ease of management by merchants. In another embodiment, category information may be inferred by context using natural language processing algorithms. In this embodiment, advertisement information and preference filter information are indexed based on keyword, keyword frequency and keyword relationships on a coordinate plane using methods such as latent semantic analysis, and keyword groups are formed due to the similarity of keywords to “concepts,” or categories.

“Type of sale information” may include clearance promotions, regular promotional offers, Back-to-School promotions, Black Friday promotions, buy-one get-one 50% off promotions, Mother's Day or Father's Day promotions, Valentine's Day promotions, etc. for the purpose of organizing advertisement content at the server.

“User information” (also known as “user profile” or “user profile information”) may include one or more device profiles or client profiles utilized by the end user to access the commerce network, i.e. the integration point of the user to the network. Access may be granted to user profiles through one or more user accounts on an Internet website, one or more social network profiles, one or more user devices, one or more second or third party applications on an application platform such as Facebook™, Apple iPhone™, Twitter™, Research in Motion (RIM) Blackberry™, Google Android™, etc. In most cases, users may be connected to the Internet and gain access to the Internet through a wireless network (e.g. local area network (LAN), wide area network (WAN), personal area network (PAN), etc.) or cellular network in accessing the commerce network described herein.

“Ad identification” may include embedded content (e.g. UPC barcodes, QR codes, etc.) in an ad creative for the purpose of redeeming the advertisement from one or more user clients directly from scanning the embedded content or through a landing page link or URL associated with the embedded content. In one embodiment, ad creative content may be displayed on a user client for redemption by a merchant, i.e. with a barcode scanner such as in a store to identify and redeem an advertisement. In a second embodiment, ad creative content may exist separately to a user client on promotional material (e.g., a poster, flyer or brochure) for redemption by the end user who utilizes a user client (such as a device) as a scanner, through built in scanner technology or third party barcode scanning applications. This enables promotional material to be printed and distributed for ease of redemption through embedded ad identification from a user client device operating as a barcode scanner, or likewise, promotional material embedded in ad creative content directly on a user client device for redemption by an advertiser at a merchant location.

“Screens” may include any means for generating a visual representation for a consumer including desktop monitors, laptop screens, or screens on portable handheld devices.

A “sales-tag” may include a peer-to-peer recommendation between two members of the commerce network. The recommendation may be performed by a single recommending user of an advertisement to one or more peers within one degree of separation in the social graph of the recommending user. Sales-tags may include the associated advertisement and a personal message in the form of text, images or video sent from the recommending user as part of the sales-tag. Sales-tags may also be distributed in a viral fashion from a single member to one or more one or more peers or immediate neighbors, followed by sales-tags from one or more of those peers to their immediate neighbors and so on. In this fashion, awareness of trusted and high quality advertisements is extended through social networks using word-of-mouth in the commerce network to propagate sales knowledge.

A “document” is to be broadly interpreted to include any machine-readable and machine-storable work product. A document may be a file, a combination of files, one or more files with embedded links to other files, etc. The files may be of any type, such as text, audio, image, video, or a combination of types. Parts of a document to be rendered to an end user can be thought of as “content” of the document. A document may include “structured data” containing both content (words, pictures, etc.) and some indication of the meaning of that content (e.g., e-mail fields and associated data, HTML tags and associated data, etc.) In the context of the Internet, a common document is a Web page. Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location. An URL is a unique address used to access information on the Internet. A document can also be rendered on one or more user clients such as a mobile device as a single screen as part of a built-in device application or second party application on an application platform such as Facebook™, Apple iPhone™, Twitter™, Research in Motion (RIM) Blackberry™, Google Android™, etc.

A “page” is to be broadly interpreted as a Web page, or a personal online space of a member in the commerce network such as an admin panel on the merchant account Web page.

### Exemplary Embodiments

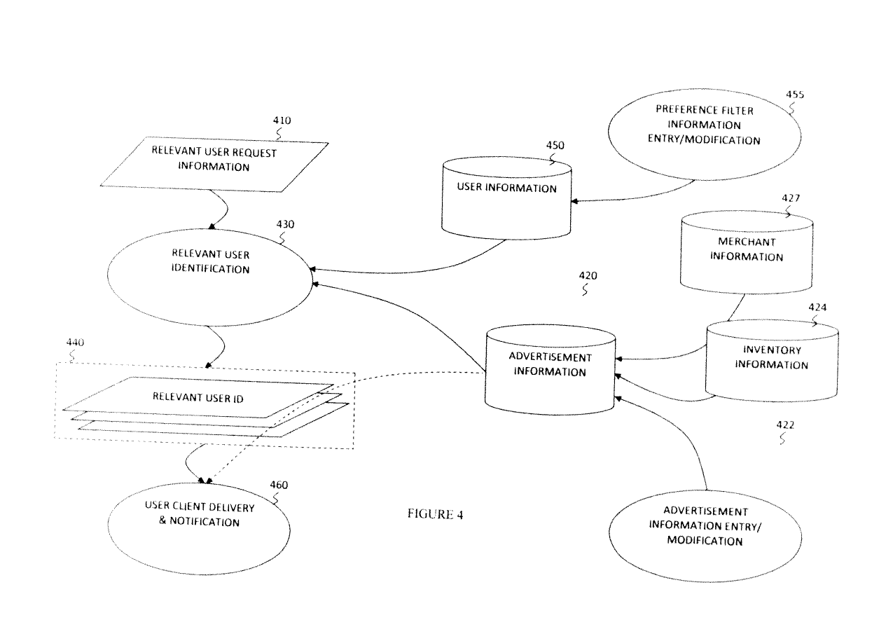

FIG. 4 is a bubble diagram illustrating various operations that may be performed by the present invention in handling relevant user request information 410 in response to new advertisement information 420 being made available by one or more merchants in the commerce network, and various information that may be used and/or generated by the present invention. In one embodiment, relevant user identification 430 may be used to retrieve a set of relevant user identifiers 440 using advertisement information 420 to whom the advertisement is valid based on user-defined preferences, relevant user request information 410, and user information 450 containing user preference filter information associated with the request information 410. Preference filter information specifies advertisement material that a consumer is willing to receive at any point in time. The relevant user identifiers 430 are those user identifiers in user information 450 whose associated preference filter information either contain: a merchant identifier associated with the new advertisement information; one or more merchant location identifiers as participating locations posted by a merchant in association with the new advertisement information; keyword information comprising one or more items of interest that the consumer is seeking; and/or, geolocation targeting information consisting of one or more regions in which the consumer is willing to receive advertisement information, a region in which one or more participating merchant locations or keywords exist associated with the new advertisement information. For example, preference filters may contain select merchant identifiers by name such as the Starbucks Coffee Company, specific merchant location identifiers such as the Starbucks location at 462 Powell Street in San Francisco, Calif. that the user may frequent, specific product/service keywords such as “latte” or “coffee” that interest the consumer at that time, and/or geolocation targeting information such as the entire San Francisco, Calif. region that the user is willing to receive information from related or unrelated to other set terms based on selected preference. If the new advertisement information matches the preference filter of any consumer in the commerce network, the consumer's user identifier is deemed a relevant user identifier 430. Exemplary methods that may be used for the preference filter information entry/modification 455 are described in Section 5.2.2 below with references to FIG. 5.

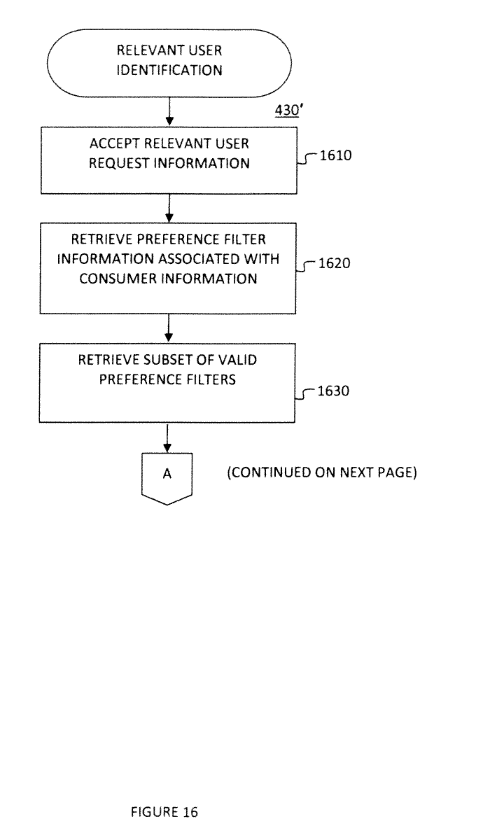

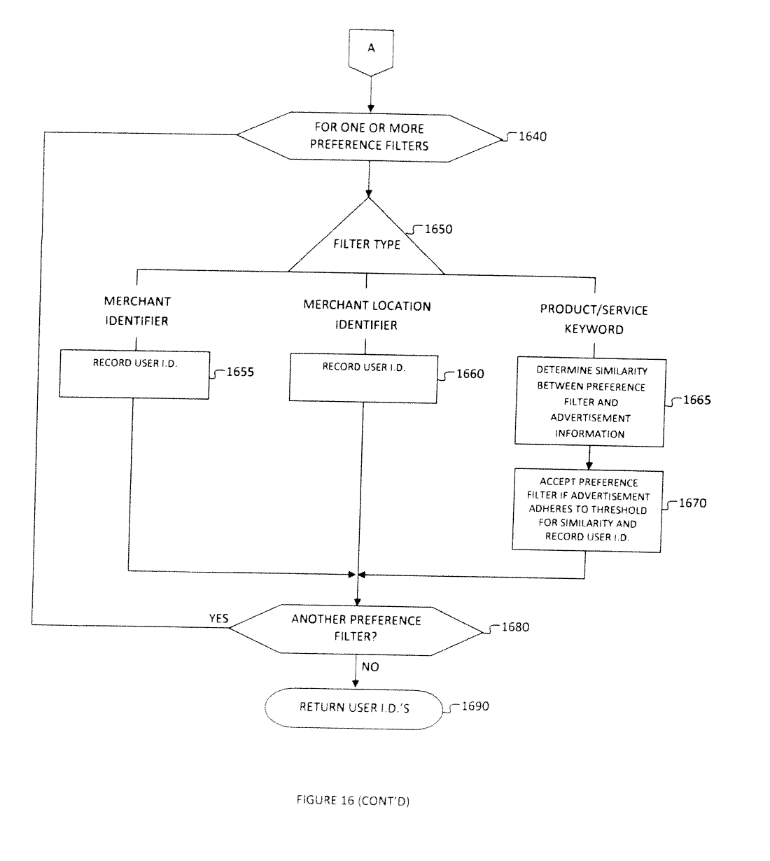

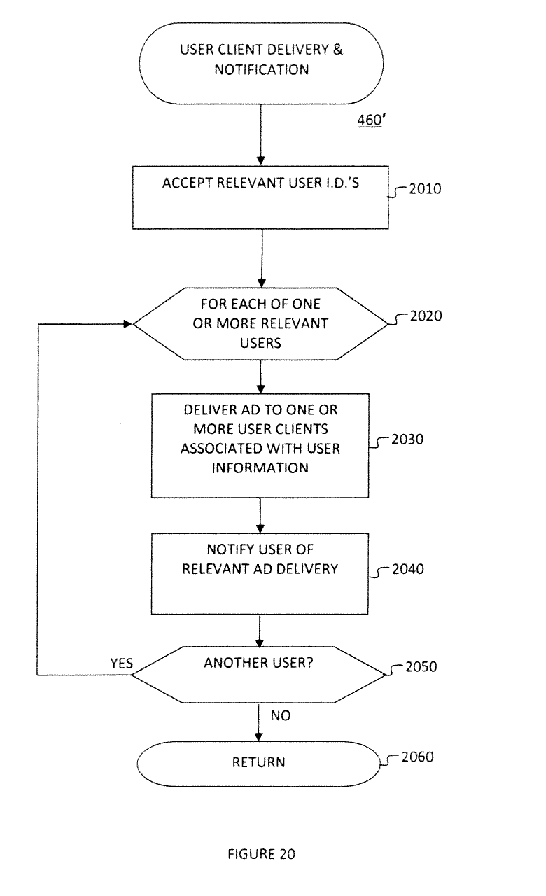

In one embodiment, the relevant user request information 410 is received by the system and searches user information 450 upon entry of new advertisement information 420 by a merchant. User client delivery & notification 460 may be used to deliver the new advertisement information to one or more relevant user identifiers 430 on one or more user client devices and/or profiles and to notify the relevant users of new preference filter search results. Exemplary data structures that may be used to store or retrieve relevant user request information 410, advertisement information 440 and user information 450 are described in Section 5.2.1 below with reference to FIGS. 5, 6, 7, 8, 9, 10, 11, 12, 13 and 14. Exemplary methods that may be used for the relevant user identification 430 and user client delivery & notification 460 are described in Section 5.2.2 below with reference to FIG. 16 and FIG. 20, respectively.

The advertisement information 420 is a database of advertisements existing on one or more network servers and entered by one or more merchants using the advertisement information entry/modifications portal 422. Inventory information 424 that is available for purchase in association with the advertisement may be specified by product/service descriptor (i.e. text title and description), product/service identifiers (i.e. model numbers, serial numbers, UPC barcode numbers, product/service item numbers available in a merchant's catalogue or menu, for example, etc.), ad creative content (i.e. pictures, video, etc.), or page links or URLs for product information on an independent website. Inventory information 424 may also include price and quantity information for one or more products/services to inform consumers about the cost and availability of those items, respectively. In one embodiment, inventory information 424 that is available for purchase in association with the advertisement is strictly listed as part of the advertisement with embedded product/service details and stored in a single database table on the ad server. In a second embodiment, advertisement information 420 and inventory information 424 are stored in separate tables in a single database on the ad server. In this embodiment, advertisement information 420 lists inventory that is available for purchase in association with the advertisement separately to advertisement information as product/service attachments and links to the inventory table to access inventory related to the advertisement. For example, an advertisement in the ad server for “20% off all Sony XBR HDTVs” from merchant Future World may contain links to all available television models (including price and quantity information) in Future World's listed inventory on the ad server that are available for purchase in association with the advertisement. In a third embodiment, advertisement information 420 may link to inventory information in separate database on the ad server. In a fourth embodiment, advertisement information 420 may be stored in an internal database on the ad server while inventory information may be stored on a merchant system and be received as input by the system.

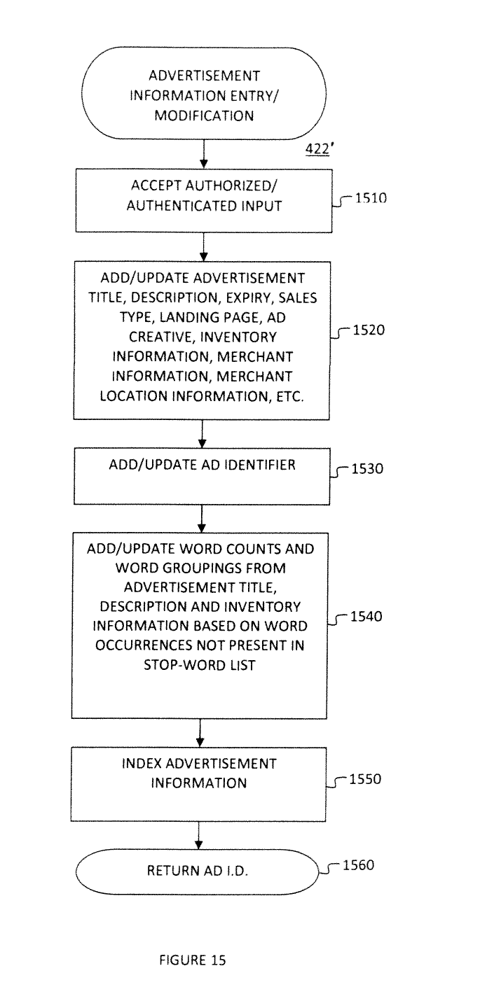

The advertisement information 420 is also leveraged by the use of merchant information 427 that contains merchant location information including geolocation information and inventory information of one or more merchant locations. The use of geolocation information in advertisement information 420 provides consumers with information on one or more participating merchant locations in relation to an advertisement and also provides the ability for the system to maintain inventory information (and related price and quantity information) at one or more merchant locations. By providing the same embodiments for merchant information 427 as inventory information 424 discussed above, these embodiments for advertisement information 420 provide functionality for product search. This novel approach to product search enables consumers who may be specifically looking for a certain products or services to find one or more merchants offering the product or service through a search by available quantity, geolocation and price. The user subsequently has complete information to make a more informed shopping decision. Exemplary methods that may be used for the advertisement information entry/modification 422 are described in Section 5.2.2 below with references to FIG. 15.

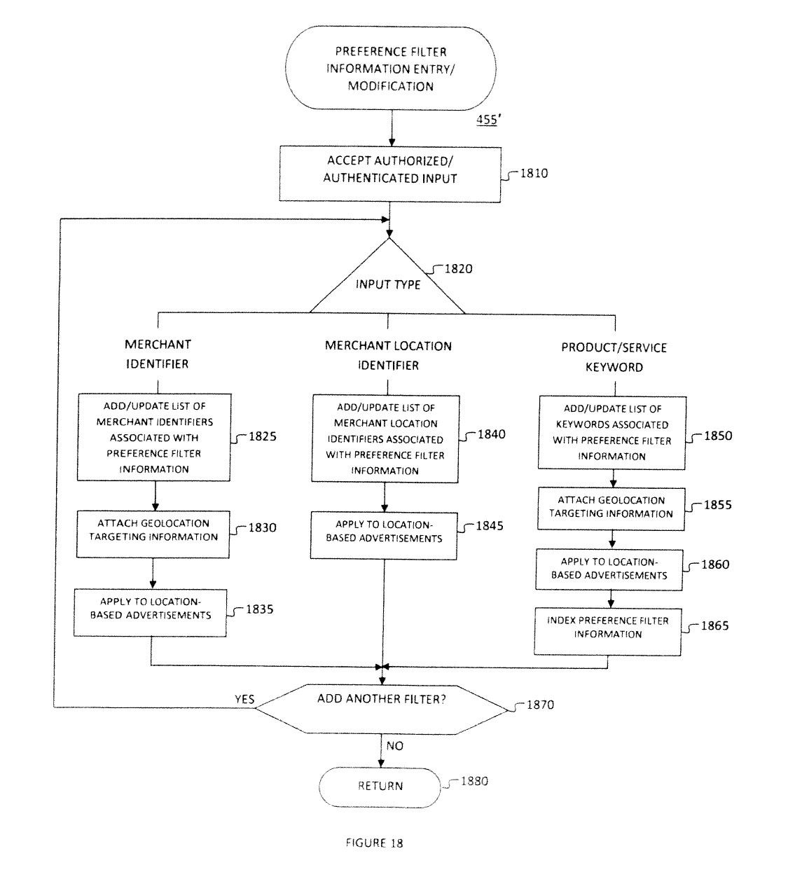

FIG. 22 is a bubble diagram illustrating various operations that may be performed by the present invention in handling preference filter request information 2210 in response to new preference filter information submitted by a consumer to receive relevant advertisement information 420′ in the commerce network, and various information that may be used and/or generated by the present invention. In one embodiment, preference filter ad selection 2220 may be used to retrieve a set of preferred advertisement identifiers 2230 using advertisement information 420′ that are deemed relevant based on user-defined preferences, preference filter request information 2210, and user information 450′ containing preference filter information associated with the request information 2210. The preferred advertisement identifiers 2230 are those advertisement identifiers in advertisement information 420′ that are relevant to the new preference filter information submitted by the consumer and are associated with: a merchant identifier specified in the new preference filter information; one or more merchant location identifiers as participating locations posted by a merchant specified in the new advertisement information; keyword information comprising one or more items of interest that the consumer is seeking as specified in the new preference filter information; and/or, geolocation targeting information by containing one or more participating merchants locations within one or more regions in which the consumer is willing to receive advertisement information from. Exemplary methods that may be used for the preference filter information entry/modification 455′ as discussed earlier are also described in Section 5.2.2 below with references to FIG. 18.

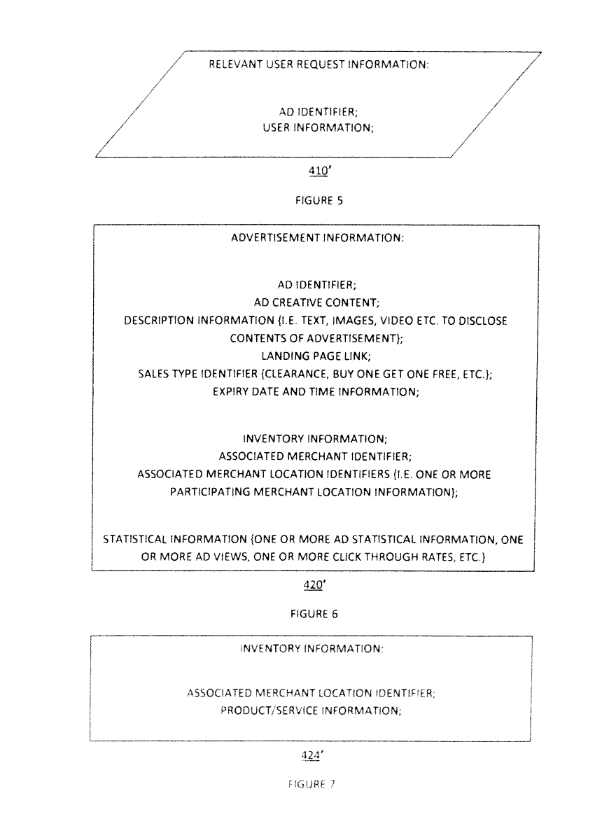

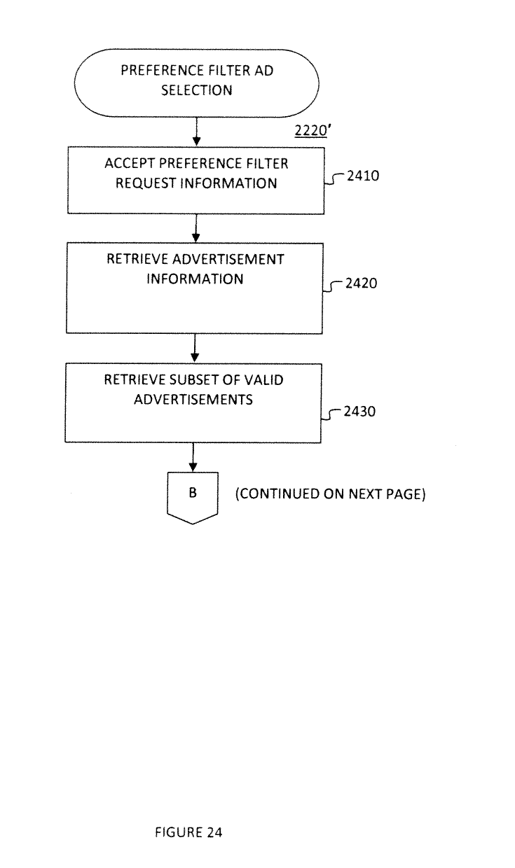

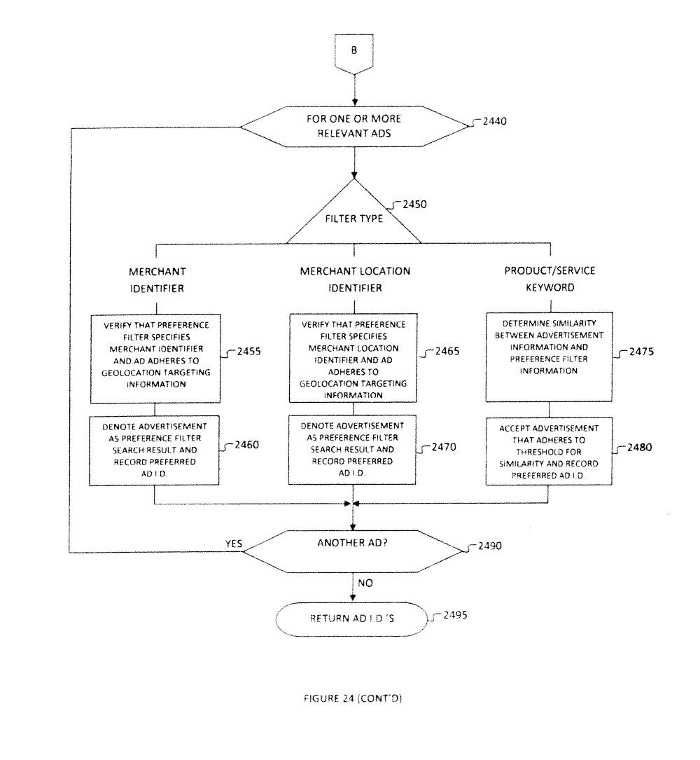

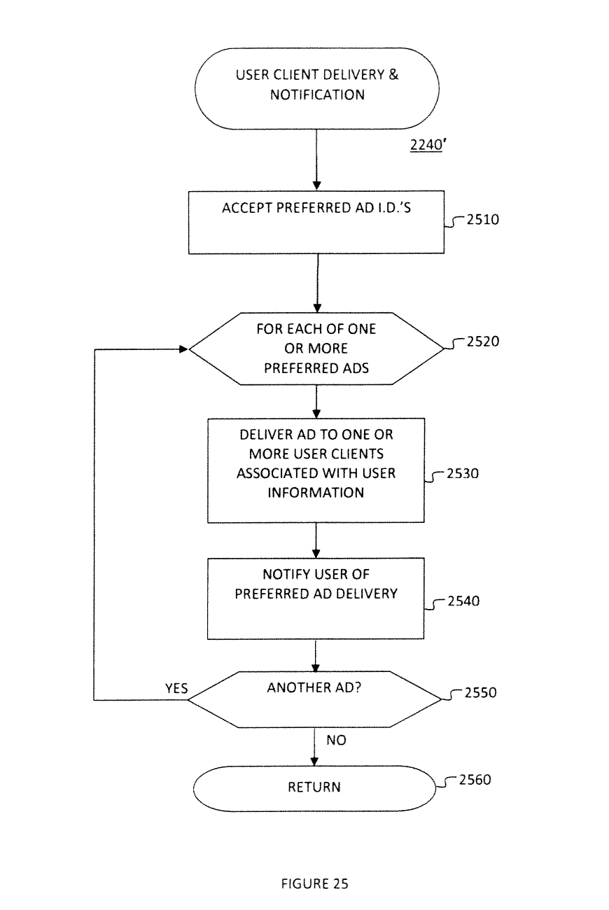

In one embodiment, the preference filter request information 2210 is received by the system and searches advertisement information 420′ periodically after a certain duration has elapsed (e.g. once an hour, once every 24 hours, three times a week, etc.) and returns relevant results to the user. In a second embodiment, the search according to preference filter information may occur only when a new preference filter term is set and/or new content is posted by a merchant in real-time. User client delivery & notification 2240 may be used to deliver the preferred advertisement identifiers 2230 to one or more user client devices and/or profiles and to notify the relevant users of new preference filter search results. Exemplary data structures that may be used to store or retrieve advertisement information 420′, user information 450′ and preference filter request information 2210 are also described in Section 5.2.1 below with reference to FIGS. 6, 7, 8, 9, 10, 11, 12, 13, 14 and 23. Exemplary methods that may be used for the preference filter advertisement selection 2220 and user client delivery & notification 2240 are described in Section 5.2.2 below with reference to FIG. 24 and FIG. 25, respectively.

Preferred advertisements 2230 are those advertisements in the advertisement information 420′ that are successful in an automatic system search by the system based on preference filter information entered by the consumer. Preference filter information may contain specific merchant identifiers such as names, one or more specific merchant locations, and/or product/service keywords that interest a user. Product/service keywords may include descriptors (e.g., “crocs”, “Las Vegas” or “hamburgers”) and/or unique product/service identifiers (e.g., model numbers, serial numbers, UPC barcode numbers, product/service item numbers available in a merchant's catalogue or menu, etc.) for the purpose of the user receiving real-time information through automatic product/service searches by the system for these shopping preferences set by the user. For example, a user may be currently interested in only receiving ad information automatically that relates to “flights to Las Vegas. Nevada” and the “SONY XBR60LX900 3D HDTV” based on current shopping preferences. The preferred advertisement 2230 for this preference filter request information 2210 may be all advertisements existing in the advertisement 420′ that contain any of the preference filter terms, i.e. all ads that are either relevant to “flights to Las Vegas, Nev.” or “SONY XBR60LX900 3D HDTV”, at the time that the preference filter request information 2210 is received by the system. Preference filter information may also include, or work in conjunction with, geolocation targeting information such as one or more regions to limit searches for advertisements to only certain desired areas. If advertisement information matches the new preference filter of the consumer in the commerce network, the advertisement identifier is deemed a preferred advertisement identifier 2230. Exemplary methods that may be used for the advertisement information entry/modification 422′ are also described in Section 5.2.2 below with references to FIG. 15.

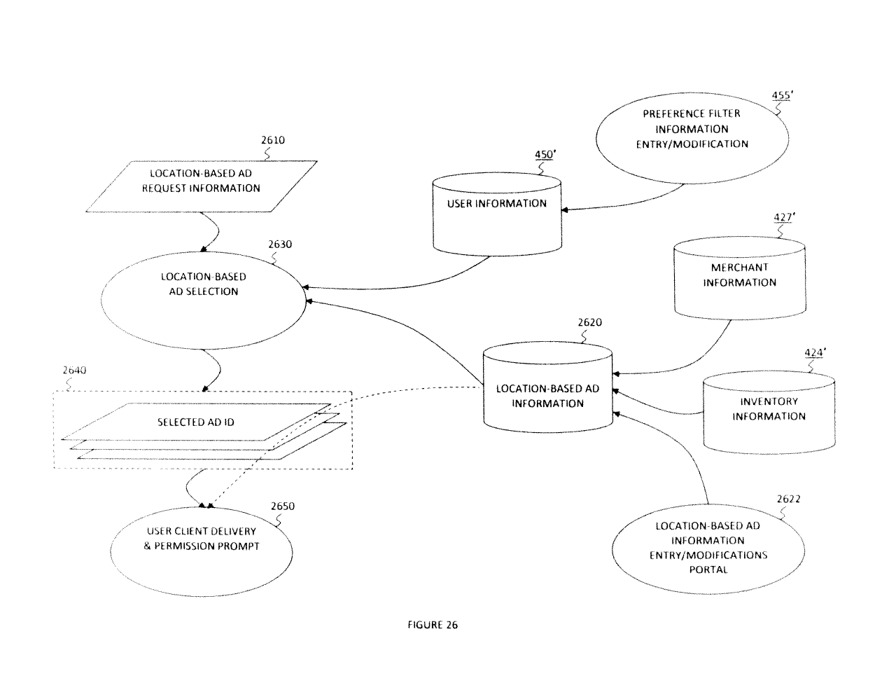

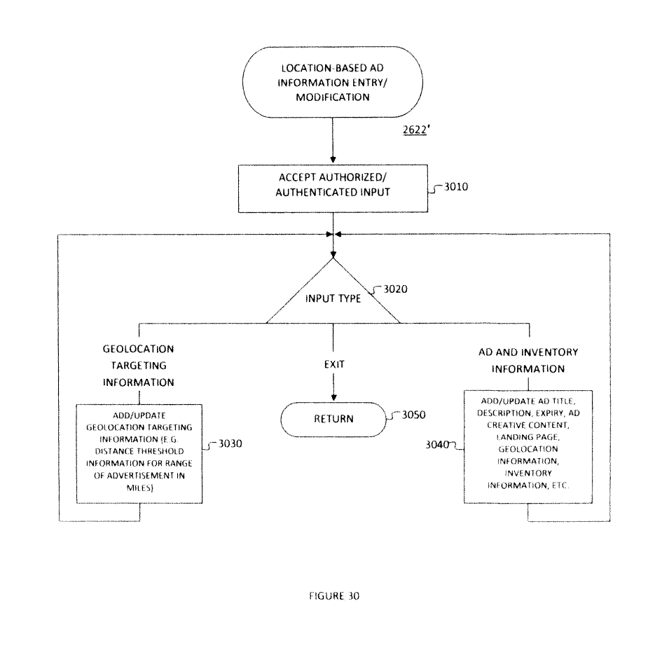

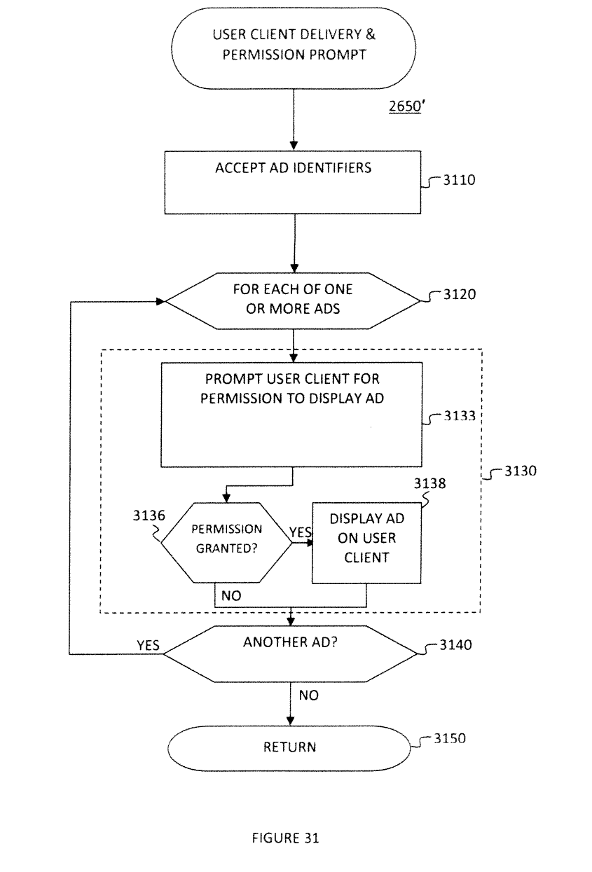

FIG. 26 is a bubble diagram illustrating various operations that may be performed by the present invention in handling location-based advertisement request information 2610 to display one or more location-based advertisement information 2620, and various information that may be used and/or generated by the present invention. Location-based advertisement selection 2630 may be used to retrieve a set of location-based ads 2640 using location-based advertisement information 2620, location-based advertisement request information 2610, user information 450′ containing the user's preference filter information, geolocation information and/or geolocation targeting information, and merchant information 427′ including geolocation information and/or geolocation targeting information. The selected advertisements 2640 are those advertisements in the location-based ad information 2620 that adhere to both the geolocation targeting information set by the user and merchant under consideration, as well as preference filter information of the user contained in user information 450′. For example, a user may set a preference filter to only receive location-based offers from “cafes” or “coffee shops” within a particular region. A user's preference filter information may also include, or work in conjunction with, specific merchant location information that limits location-based ads from only certain desired merchant locations. Merchants, on the other hand, may have a self-imposed or system limit that defines the maximum range of a location-based advertisement extending outwards from their merchant location's geolocation in a circular fashion. Merchant geolocation targeting information may be set and modified by merchants in the location-based ad information entry/modification 2622. Users may only be delivered an offer from a merchant if both the user and merchant are within each of their desired geolocation targeting limits of each other and the offer adheres to the content of the user's set preference filter, in this case “cafes” or “coffee shops”. Selected location-based advertisements 2640 are considered as offers as they may be delivered to one or more user clients using a permission prompt asking the user for permission prior to displaying one or more relevant ads 2640. Permission prompts are used by the commerce network to give consumers more control over ad content that they consume and may be delivered to one or more user clients using the user client delivery & permission prompt 2650. Exemplary data structures that may be used to store or retrieve user information 450′, merchant information 427′, location-based ad request information 2610 and location-based ad information 2620 are described in Section 5.2.1 below with reference to FIGS. 9, 13, 27 and 28, respectively. Exemplary methods that may be used for the location-based ad selection 2630 and user client delivery & permission prompt 2650 are described in Section 5.2.2 below with reference to FIGS. 29 and 31, respectively.

The location-based advertisement information 2620 is a database of location-based advertisements entered and maintained by one or more merchants using the location-based ad information entry/modifications portal 2622. In one embodiment, location-based ads are entered with an offer message, and timestamp information for date and time expiry of the offer. For example, given our previous example of a user's set preference filter, in this case “cafes” or “coffee shops”, a coffee shop merchant may create an offer for users of “Come into Coffee Bean in the next 20 minutes for a free coffee.” With embedded date and time information and the offer that includes the limited-time nature of the promotion, the merchant has sufficient information to note the validity of the offer upon arrival of a consumer asking to redeem the offer before expiry. In a second embodiment, location-based advertisements may also include inventory information (i.e. product/service information including model numbers, serial numbers, UPC barcode numbers, etc.) as part of an offer if the merchant is willing to sell the inventory item at a discounted price based on the existence of the inventory item in the consumer's preference filter. For example, if a user has a preference filter term set for the “SONY XBR60LX900 3D HDTV” as in a previous example but has yet to purchase one due to the user not yet finding the desired price, a merchant may decide to sell the product for a special price below advertised prices in order to make a sale and remove the product from inventory. The user would, then, for example, receive an offer from the merchant Future World of “Future World is willing to sell you the SONY XBR60LX900 3D HDTV at $100 off if you purchase in the next 24 hours. Would you be interested?” Again, with embedded date and time information, the merchant has sufficient information to validate a location-based advertisement if a user comes into the merchant location to redeem the offer. Exemplary methods that may be used for the location-based advertisement information entry/modifications 2622 are described in Section 5.2.2 below with references to FIG. 30.

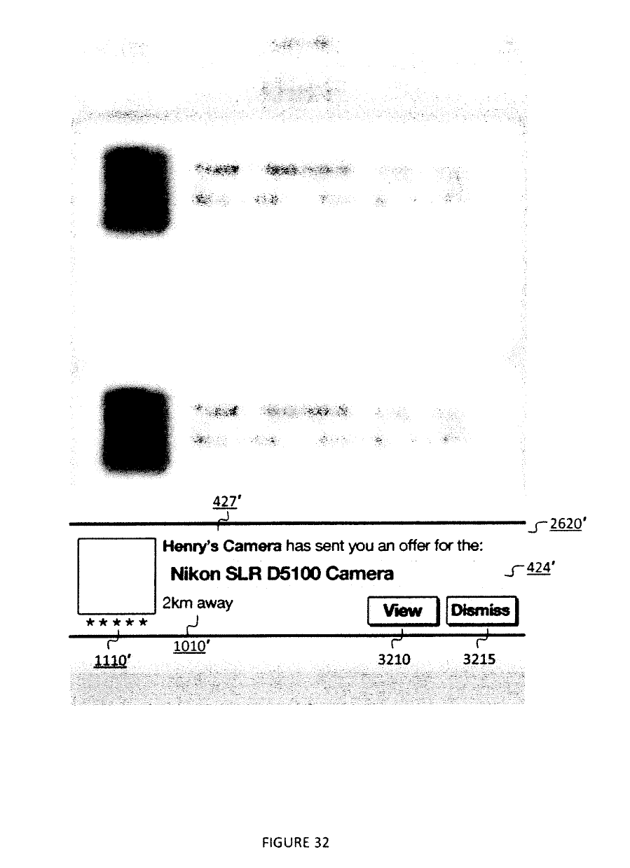

FIG. 32 is a bubble diagram illustrating the various operations that may be performed by the present invention in handling sales-tagging request information 3410, and various information that may be used and/or generated by the present invention. Sales-tag delivery 3420 may be used by the system to transmit a sales-tag, or a peer-to-peer recommendation for advertisement information 420′, from a recommending member of the commerce network to one or more recommendation target users using sales-tagging request information 2210, user information 450′, and advertisement information 420′. In one embodiment, a sales-tag may be performed by a single recommending user of an advertisement to one or more peers within one degree of separation in the social graph of the recommending user. Peers within one degree of separation from a member are known as the immediate neighbors of the member to whom the member is directly connected. In a second embodiment, multiple sales-tags may occur in a viral fashion from a single member to one or more one or more peers or immediate neighbors, followed by sales-tags from one or more of those peers to their immediate neighbors and so on. In this fashion, awareness of trusted and high quality advertisements is extended through social networks using word-of-mouth in the commerce network to propagate sales knowledge. For example, consider that 10 users of the commerce network come across a recently posted advertisement in advertisement information 420′ by an airline company for “50% off all flights for the next 24 hours.” If these 10 members each tell 10 peers in their social networks, who each tell 10 peers in their own social networks, assuming no overlap of peers in their social networks, 1000 users can become aware of the flight seat sale almost instantly and may take advantage of the sale quickly as sales-tags are propagated using sales-tag delivery 3420. In a third embodiment, sales-tags may be transmitted with a personal message by the recommending user in the form of text, images, video, etc. to describe the sales-tag. In a fourth embodiment, if a personal message by the recommending user is not provided, a system-generated message can accompany the sales-tag. Prior to this technology, it was not currently possible for recommendations for advertisements to be distributed in this fashion in a commerce network. Many times consumers may enter stores and it is cumbersome to inform any number of friends, family members or colleagues about great sales promotional information that they have come across. Consumers subsequently fail to take advantage through a lack of information and merchants suffer through poor awareness. The sales-tag delivery 3420 between members of a social network in a commerce network that is consistent with the present invention is critical to improving the social discussion related to sales promotional information and helping people find relevant sales promotional material through social relationships. Ad statistical information 1210′ may be stored to record the user identifiers of one or more recommending users, recommendation counts for the number of peers who are sent the sales-tag, and the user identifiers of one or more recipient users, along with timestamp information for the sales-tags. Advertisement information entry/modifications 422′ was introduced earlier but will be covered in more depth in Section 5.2.2. Exemplary data structures that may be used to store or retrieve advertisement information 420′, user information 450′, sales-tagging request information 3410, and ad statistical information 1210′ are described in Section 5.2.1 below with reference to FIGS. 6, 12, 13 and 35, respectively. Exemplary methods that may be used for sales-tag delivery 3420 are described in Section 5.2.2 below with reference to FIG. 36.

The present invention need not provide, and/or use all of the operations and information described with reference to FIGS. 4, 22, 26 and 34. The present invention need not perform the operations in the order shown. Finally, the present invention may combine, or separate functionality described with respect to the various operations.

### Exemplary Data Structures

The following data structures are databases that are stored on hard drives on one or more computer servers comprising the commerce network and may be accessed over a network and the Internet:

FIG. 5 illustrates exemplary relevant user request information 410′ in one embodiment that is consistent with the present invention. The relevant user request information 410′ may include information such as that described Section 5.1.1 above. Further, the relevant user request information 410′ in one embodiment may include an ad identifier and user information 450.

FIG. 6 illustrates exemplary advertisement information 420′ in one embodiment that is consistent with the present invention. The advertisement information 420′ in one embodiment may include information such as that described in Section 5.1.1 above. For example, the advertisement information 420′ in one embodiment may consist of an ad identifier, ad creative content (or a reference to ad creative content), description information including text, images, video, etc. for the purposes of disclosing contents of the advertisement to consumers, landing page link, sales type identifier and expiry date information. Ad creative content may also be associated with advertisement information 420′ with embedded ad identification using, at least. UPC barcodes, two-dimensional Quick Response (QR) codes, etc., to redeem an ad or promotion directly from a user client device using, for example, a merchant barcode scanner: i) directly from the ad creative from which embedded content is retrieved to identify the ad such as with an electronic coupon on a user client device, or ii) through a landing page link, URL, etc., embedded in the ad identification such as is possible with QR codes and other variations of QR codes. For example, a merchant may embed a barcode in an ad creative that users may bring into a merchant location on a user client device for redemption by the merchant by scanning the user client device. Ad creative content with embedded ad identification may also display separately to a user client on promotional material as an independent ad for redemption by the end user who utilizes a user client device as a scanner, either through built in barcode scanner technology or third party barcode scanning applications on the user client device. For example, an advertiser may display ad posters with embedded ad identification that a user may scan with a barcode scanner on a user client device and may bring in the associated ad to the merchant location for redemption. In another embodiment, the advertisement information 420′ may also include inventory information 424 of one or more product/service available for purchase in association with the advertisement information 420′, the associated merchant identifier for which the advertisement information 420′ is posted, and associated merchant location identifiers of one or more participating merchant locations at which the advertisement information 420′ is applicable. For example, a coffee shop chain can make an ad available to only specific locations, or a nationwide wireless provider can make an ad available to students across the country redeemable at any of its locations. In another embodiment, the advertisement information 420′ may also include statistical information including one or more ad statistical information 1210 relating to recommendations of the advertisement information 420′ made by one or more consumers, one or more ad view counts, one or more click through rates to the landing page link, etc.

FIG. 7 illustrates exemplary inventory information 424′ in one embodiment that is consistent with the present invention. The inventory information 424′ in one embodiment may include information such as that described in Section 5.1.1 above. For example, in one embodiment, inventory information 424′ may include an associated merchant location identifier and product/service information for the purpose of disclosing the available quantity of an item at one or more merchant locations.

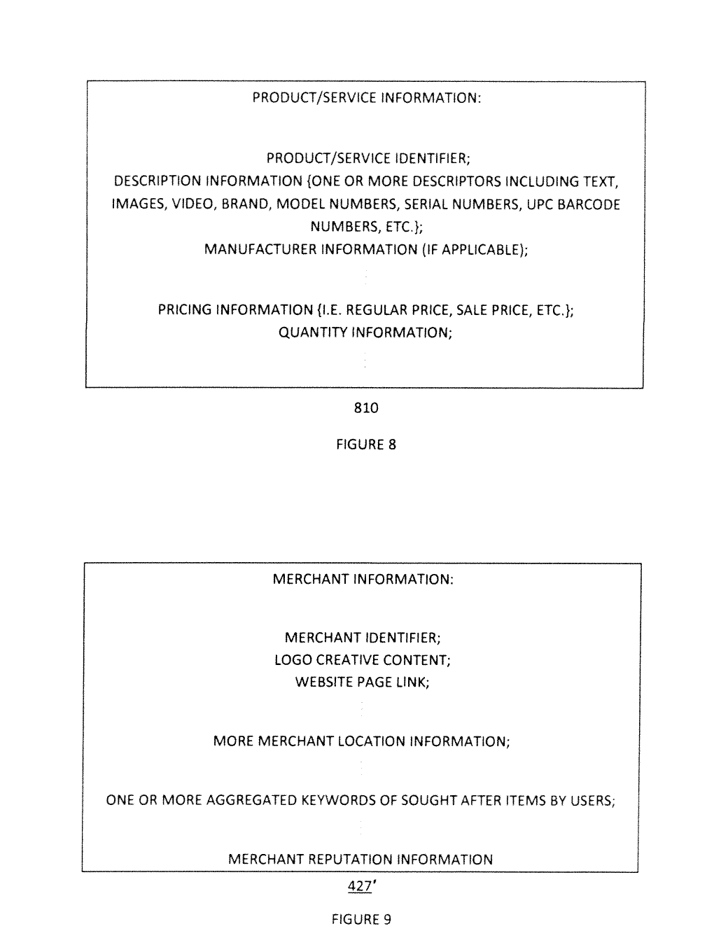

FIG. 8 illustrates exemplary product/service information 810 in one embodiment that is consistent with the present invention. The product/service information 810 in one embodiment may include information such as that described in Section 5.1.1 above. For example, in one embodiment, product/service information 810 describes a single product/service offered by a merchant and may include a single product/service identifier assigned by either the system or merchant, description information including product descriptors such as text, images, video, etc., model numbers, serial numbers, UPC barcode numbers, etc., and manufacturer information (if applicable). In another embodiment, product/service information 810 may also include pricing information in the form of the regular price and sale (discounted) price to inform consumers of price markdowns in relation to the product/service information. In another embodiment, product/service information 810 may also include quantity information associated with product/service information to inform consumers of the number of items available for purchase. Product/service information 810 is organized by merchant location to provide consumers with product/service information at merchant locations around them.

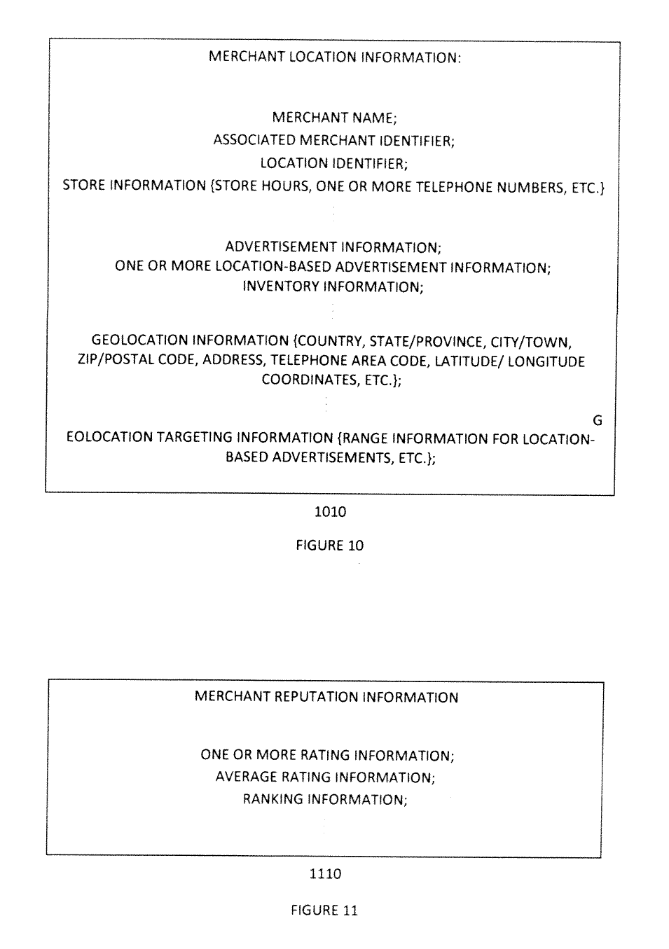

FIG. 9 illustrates exemplary merchant information 427′ in one embodiment that is consistent with the present invention. The merchant information 427′ in one embodiment may include information such as that described in Section 5.1.1 above. For example, the merchant information 427′ in one embodiment may include merchant identifiers, logo creative content (or links to logo creative content), and website page links or URLs. In another embodiment, merchant information 427′ may include merchant location information of one or more locations associated with the merchant information 427′. In another embodiment, merchant information 427′ may include one or more aggregated keywords of sought after items by users that are aggregated by the system and provided to the merchant for the purpose of informing merchants about products and/or services that consumers are seeking at that point in time. In another embodiment, merchant information 427′ may also include merchant reputation information 1110. FIG. 10 illustrates exemplary merchant location information 1010 in one embodiment that is consistent with the present invention. The merchant location information 1010 in one embodiment may include information such as that described in Section 5.1.1 above. For example, the merchant location information 1010 in one embodiment may consist of a merchant name unique to that merchant location, the associated merchant identifier (i.e. of the parent, or main, merchant account), The location identifier specific to the merchant location, and store information that contains information relating to store hours of operation and one or more contact telephone numbers. In another embodiment, merchant location information 1010 may also include advertisement information 420 consistent with sales promotional information currently available at the merchant location. In another embodiment, merchant location information 1010 may also include location-based advertisement information 2620 that are offers that are sent out by the merchant location to one or more nearby consumers within a predetermined geographical area. These offers are meant to provide an incentive for a nearby consumer to test out the merchant's products and/or services through a highly discounted promotion and aids merchants in converting nearby pedestrians into customers. In another embodiment, merchant location information 1010 may also include geolocation information of the merchant location including the country, state/province, city/town, zip/postal code, address, telephone area code and/or latitude/longitude coordinates. In another embodiment, merchant location information 1010 may also include geolocation targeting information in the form of range information to define the geographical area around the geolocation of the merchant location for the transmission of location-based advertisements to one or more pedestrians on one or more user clients.

FIG. 11 illustrates exemplary merchant reputation information 1110 in one embodiment that is consistent with the present invention. The merchant reputation information 1110 in one embodiment may include information such as that described in Section 5.1.1 above. For example, merchant reputation information 1110 in one embodiment may consist of one or more rating information from one or more consumers that have rated a merchant, average rating information and ranking information for a merchant in relation to one or more other merchants in the commerce network.

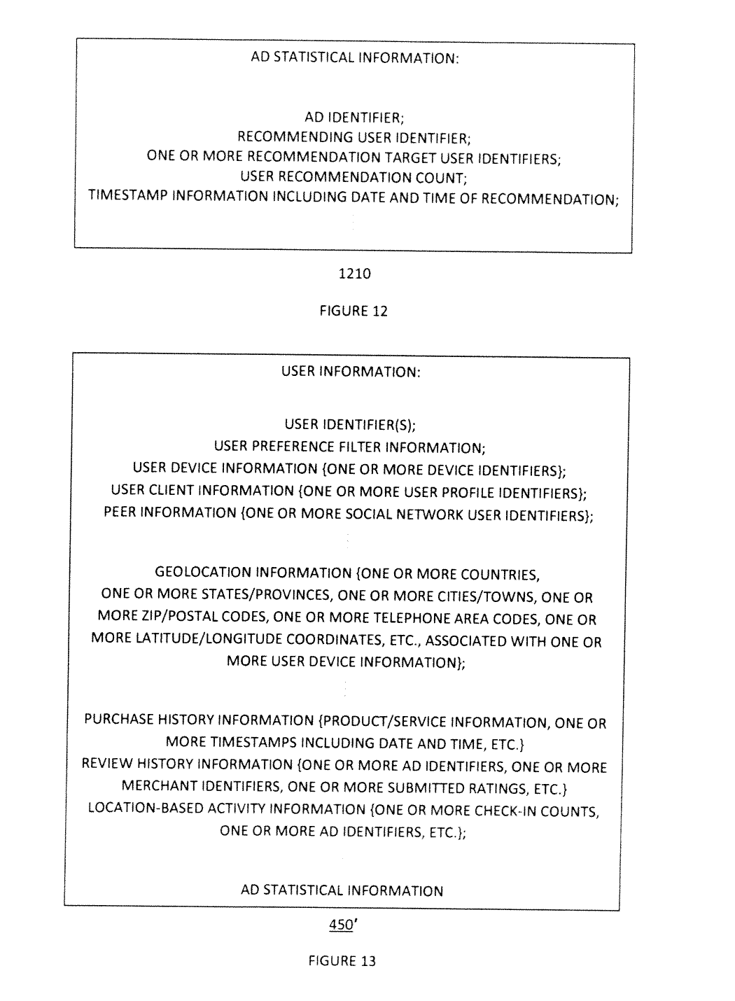

FIG. 12 illustrates exemplary ad statistical information 1210 in one embodiment that is consistent with the present invention. The ad statistical information 1210 in one embodiment may include an ad identifier, the user identifier of the recommending user, one or more user identifiers to which the sales-tag is being sent to, the total sales-tag count of a user and timestamp information of the sales-tag.

FIG. 15 presents exemplary user information 450′ in one embodiment that is consistent with the present invention. The user information 450′ in one embodiment may include one or more user identifiers such as name, email address, handle, username, telephone number, etc., user preference filter information, user client information including one or more device profiles or user profiles (such as an online social networking account) to access the commerce network, and one or more peer identifiers to identify social relationship connections. Typically, peer identifiers include those of a consumer which are within one degree of separation from the consumer and may either be stored in the system or retrieved via a third party social network application programming interface. The user information 450′ in one embodiment may also include geolocation information including country, state/province, city/town/municipality/neighborhood/locality, zip/postal code, address, telephone area code and/or latitude/longitude coordinates of one or more user device information. The user information 450′ in one embodiment may also include purchase history information of product/service information and timestamp information including the date and time of the purchase. The user information 450′ may also include review history information of one or more posted reviews by the consumer in relation to one or more ad identifiers, one or more merchant identifiers and one or more submitted ratings, etc. The user information 450′ in one embodiment may also include ad statistical information 1210 that contains information regarding one or more sales-tags made by the consumer.

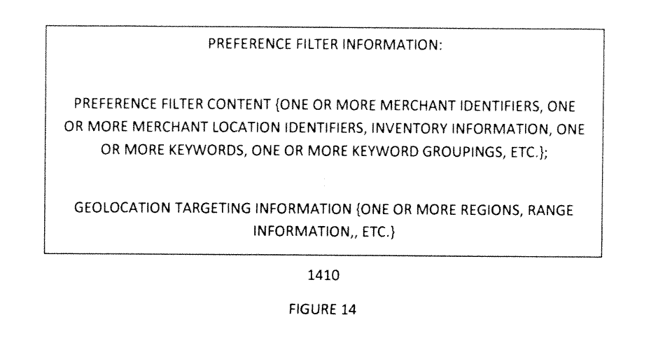

FIG. 14 illustrates exemplary preference filter information 1410 in one embodiment that is consistent with the present invention. The preference filter information 1410 in one embodiment may include information such as that described in Section 5.1.1 above. For example, preference filter information 1410 in one embodiment may include preference filter content (or a reference to preference filter content) consisting of one or more merchant identifiers. Preference filter information 1410 may also include one or more merchant location identifiers to enable consumers to select particular merchant locations of interest. For example, while selecting the merchant identifier associated with, for example, Starbucks Coffee Company would enable the consumer to receive information related to any and all promotions by the Starbucks Coffee Company, also enabling the consumer to select a particular merchant location such as the Starbucks at 462 Powell Street in San Francisco, Calif. allows the user to be aware of promotions at particular merchant locations that they may frequent regularly, such as on the way to work. Preference filter information 1410 may also include inventory information 424, one or more keywords or keyword groupings of interest to enable consumers to select particular items or categories that they would like to receive information about. Keyword groupings provide information on one or more categories of keywords grouped together that is used to determine the context of a search in relation to latent semantic analysis. These categories may reflect particular groupings of interest such as “Sports and Leisure,” “Entertainment,” “Fashion,” or “Computer & Electronics.” Preference filter information 1410 in one embodiment may also include, or work in conjunction with, geolocation targeting information such as one or more regions of interest from which the consumer is willing to receive advertisement information from regarding one or more merchants, and product and services that the consumer is currently seeking. For example, a consumer may specify geolocation targeting information if he/she is only looking to purchase a television from a local electronics store, but may also specify geolocation targeting information for merchant locations in another country if he/she is willing to purchase airline tickets from an airline based abroad, for example. The consumer may also choose to receive information from online-only promotions where purchases must be made over the Internet.

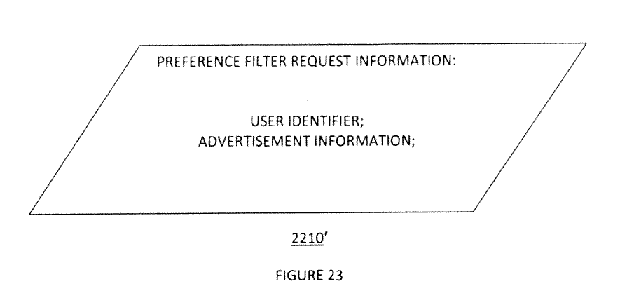

FIG. 23 illustrates exemplary preference filter request information 2210′ in one embodiment that is consistent with the present invention. The preference filter request information 2210′ in one embodiment may include information such as that described in Section 5.1.1 above. Further, the preference filter request information 2210′ in one embodiment may include a user identifier and advertisement information.

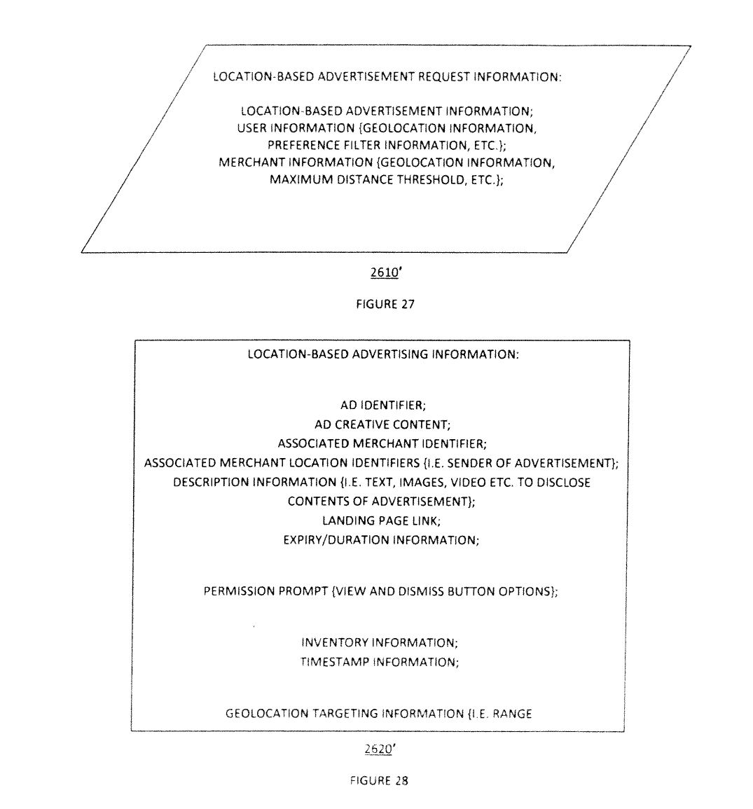

FIG. 27 presents exemplary location-based advertisement request information 2610′ in one embodiment that is consistent with the present invention. The location-based advertisement request information 2610′ in one embodiment may include the location-based advertisement information, user information including geolocation information and preference filter information at that time, as well as merchant information including geolocation information and range information.

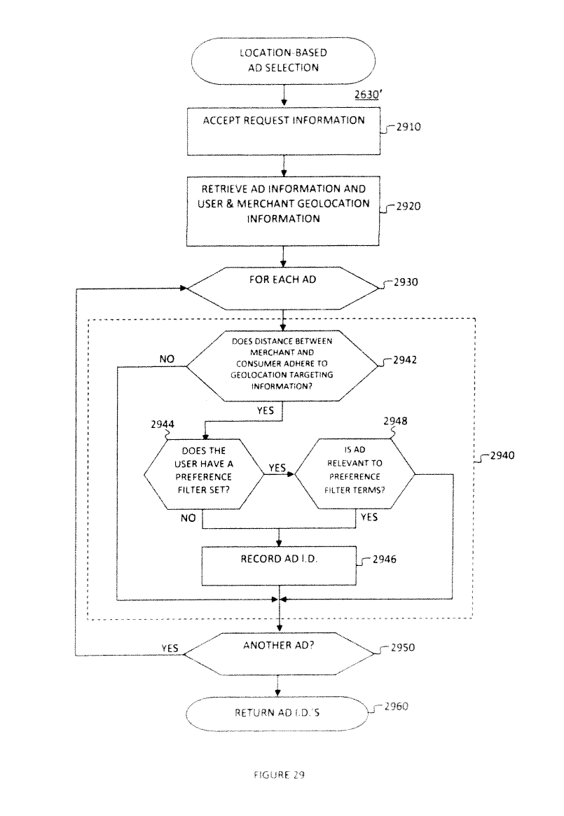

FIG. 28 illustrates exemplary location-based advertising information 2620′ in one embodiment that is consistent with the present invention. The location-based advertising information 2620′ in one embodiment may include information such as that described in Section 5.1.1 above. The location-based advertising information 2620′ in one embodiment may also include an ad identifier, ad creative content (or a reference to ad creative content), the associated merchant identifier of the location-based advertisement, one or more associated merchant location identifiers of the location-based advertisement, description information including text, images, video, etc. for the purposes of disclosing contents of the advertisement to consumers, a landing page link, and expiry/duration information associated with the limited-time availability of the location-based advertisement. The location-based advertising information 2620′ in another embodiment may also include permission prompt information in the form of two buttons, labeled “View” and “Dismiss,” which are presented to the consumer for user-granted permission prior to the display of the advertisement. The permission prompt enables consumers to gain control of the advertisements that they consume. The location-based advertising information 2620′ in another embodiment may also include inventory information 424 associated with the location-based advertisement, and timestamp information including the date and time the location-based advertisement was presented to the user. The location-based advertising information 2620′ in another embodiment may also include geolocation targeting information such as range information. Range information specifies the maximum distance away from the merchant's geolocation position in all directions for which a location-based advertisement is valid, i.e. defining a circular area around the merchant's geolocation position as an operating region within which the user's geolocation position must exist for the location-based advertisement to be delivered. This occurs for the purpose of sending out offers to nearby consumers as an incentive for them to purchase the merchant's products or services.

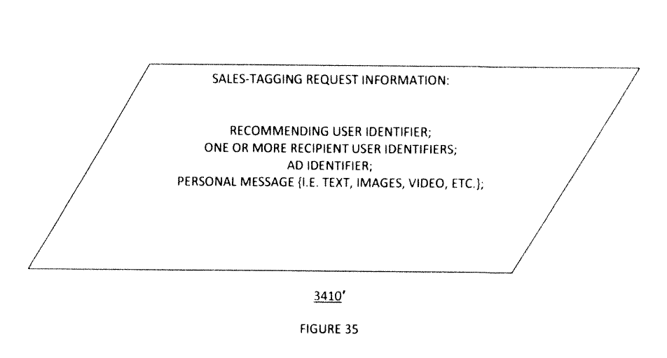

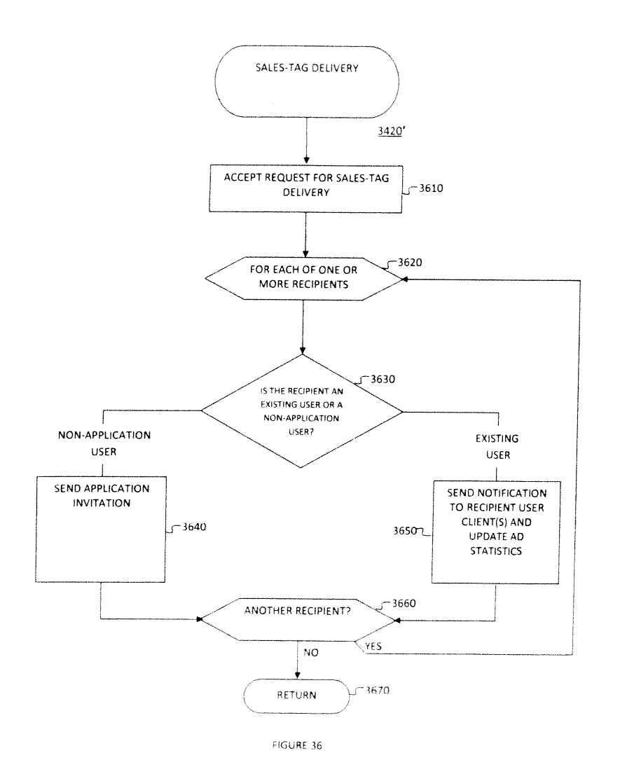

FIG. 35 presents exemplary sales-tagging request information 3410′ in one embodiment that is consistent with the present invention. The sales-tagging request information 3410′ in one embodiment consists of a recommending user identifier, one or more recommendation target user identifiers of users to whom the recommendation is being sent to, the associated advertisement identifier and a personal message from the recommending user to the recommendation target users.

### Exemplary Methods

FIG. 15 is a flow diagram of an exemplary method 422′ for performing advertisement information entry/modification operations in a manner consistent with the present invention. In one embodiment, authorized/authenticated input is accepted from the merchant (Block 1510). Recall from FIG. 6 that advertisement information 420′ may include ad identifiers, ad creative content (or a reference to ad creative content), description information, landing page link, sales type identifier, expiry date information, merchant identifier, etc. The advertisement information 420′ in one embodiment may also include inventory information including one or more product identifiers including product descriptors, model numbers, serial numbers, UPC barcode numbers, item numbers available in a merchant's catalogue or menu, etc., as well as one or more merchant location identifiers (or a reference to geolocation information of one or more merchant locations) to show availability of inventory to one or more merchant locations for the same merchant identifier. Advertisement information 420′ may also include ad creative content with embedded ad identification using, at least, UPC barcodes, two-dimensional Quick Response (QR) codes, etc., to redeem an advertisement or promotion directly from a user client device using, for example, a merchant barcode scanner: i) directly from the ad creative from which embedded content is retrieved to identify the ad such as with an electronic coupon on a user client device, or ii) through a landing page link, URL, etc., embedded in the ad identification such as is possible with QR codes, variations of QR codes, etc. After one or more input fields are entered (Block 1520) and accepted, ad identifiers are assigned and the advertisement information 420′ is stored (Block 1530).

Upon storing the advertisement information 420′ at the ad server, the word occurrences in the title, description information and inventory information associated with the advertisement information 420′ are counted where words in a stop-word list that do not affect meaning are excluded from the tally (Block 1540). To do so, a word by advertisement matrix A is maintained that stores and updates the counting data of word occurrences as new advertisement information 420′ is posted. This enables the advertisement to be indexed by the correlation between word patterns using natural language processing by latent semantic analysis to determine the context of words specified within advertisement information 420′ (Block 1550). Singular value decomposition on matrix A is then performed to determine three component sub-matrices, a word matrix U₄, an eigenvalue matrix S_{A}, and an advertisement matrix V_{A}^{T}, where A=U_{A}×S_{A}×V_{A}^{T}. Since the word by advertisement matrix A stores the word occurrences of many advertisements, dimension reductionality is performed to remove noise that exists in the data. This is achieved by choosing one or more top eigenvalues in S_{A} that also emphasizes the strongest word relationships in the consolidated advertisements. At this point, matrix U_{A} contains the coordinates of the words with the strongest word relationships from A on a coordinate plane that groups words in “concepts” based on the strength in word relationships. Advertisement matrix V_{A}^{T} contains the coordinates of the advertisements themselves on the same coordinate plane such that, by plotting the coordinates in both U_{A} and V_{A}^{T}, the context of words and their relationship to advertisements can be determined. In this manner, word relationships from one or more advertisements regarding a similar concept will gravitate towards the same word groups as more advertisements are indexed over time. In this fashion, categories that can be inferred by the concepts to which words and advertisements relate without the explicit need to state one or more specific product or service categories. However, as one experienced in the art will understand, this method can easily be extended to include the explicit use of category mapping. Upon indexing the new advertisement information 420′, the method 422′ is left (Block 1560).

In another embodiment, advertisement information entry/modification 422′ may be performed by a user if an advertisement does not exist in the ad server for which a user may desire to send a sales-tag to one or more peers. This embodiment enables sales-tags to propagate through social circles for greater awareness of sales knowledge. For example, consider a consumer at merchant Future World who sees a digital camera on sale for 50% off that he/she deems interesting for one or more of his/her peers. Performing advertisement information entry/modification 422′ enables the user to enter the details of the advertisement information 420′ from a user client and sales-tag any number of peers in this new advertisement to perform an ad recommendation. In this fashion, the present invention improves the distribution of advertisements between members of a social graph and enables recommendations of advertisements to occur on a larger scale than is currently possible with the norm. As discussed in Section 2.2, prior to the present invention, it was cumbersome for a user seeing an attractive sale to recommend it to any number of his/her peers and, as a result, both consumers, who fail to take advantage of a limited-time promotion, and merchants, who fail to extend awareness to a larger number of potential customers, suffered.

Still referring to FIG. 15, ad creative content with embedded ad identification associated with advertisement information entry/modification 345′ may display separately to a user client on promotional material as an independent advertisement for redemption by the end user who utilizes a user client device as a scanner, either through built in barcode scanner technology or third party barcode scanning applications, etc. This enables promotional material to be printed and distributed for ease of redemption through embedded ad identification from a user client device operating as a barcode scanner, or likewise, promotional material embedded in an advertisement for display on a user client for redemption by an advertiser at a merchant location. FIG. 16 is a flow diagram of an exemplary method 430′ for performing relevant user identification operations in a manner that is consistent with the present invention. Request information is accepted (Block 1610). Request information may include, among other things, the new advertisement identifier for which the system searches for relevant users based on specified preference filter information of one or more consumers. As a result, request information may also include user information associated with the request. With this request information, consumer preference filter information and the advertisement associated with the request are retrieved (Block 1620). In Block 1630, the subset of valid consumer preference filters are determined. The subset of valid consumer preference filters are determined as those that have specified the merchant associated with the new advertisement information, one or more merchant locations that are specified as participating merchant locations in association with the new advertisement information, or one or more regions in which the merchant has participating locations in association with the advertisement. In this manner, the commerce system delivers relevant information to consumers who are seeking this information.

As indicated by loop 1640-1680, an act is performed for each preference filter deemed valid. For each valid preference filter associated with the relevant user request information 410′, the type of filter is determined (Block 1650). For the preference filters that have requested to receive advertisement information by the merchant associated with the new advertisement information, the user identifiers associated with the preference filter information are simply recorded (Block 1655). Similarly, for those preference filters that have specified the merchant location identifier that is associated with the advertisement, the user identifiers associated with the preference filter information are also recorded (Block 1660). Additional operations are not performed simply because the consumer has opted in to receiving information from either the merchant of the merchant location specifically; in the case that additional geolocation information is attached to the merchant in the user's preference filter, the validity check in Block 1630 ensures that a merchant location associated with the advertisement must be located within the geolocation information specified by the user such as the specification of a region prior to the preference filter being deemed valid.

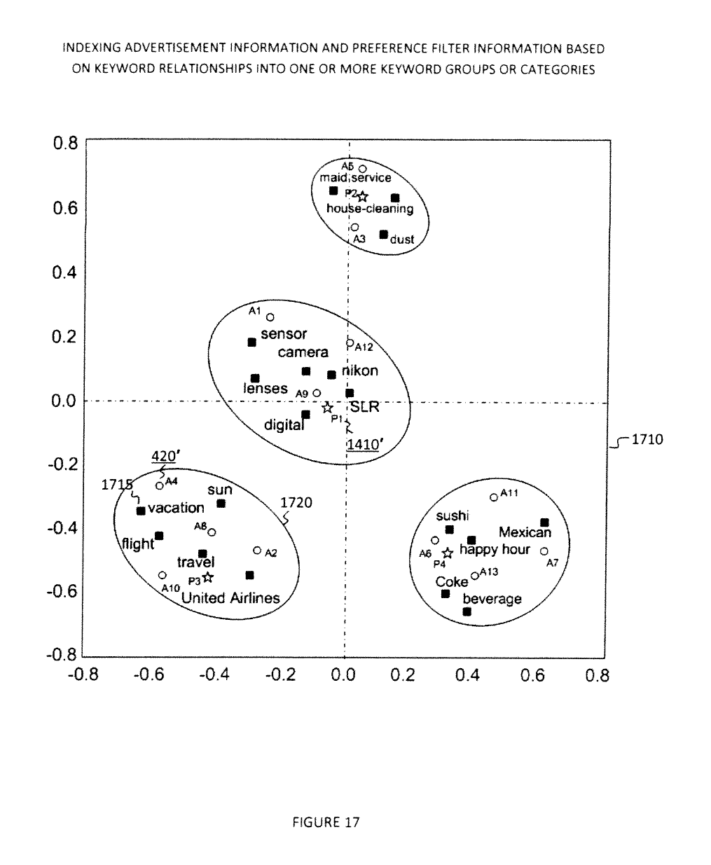

For the delivery of preference filter results based on the specification of one or more keywords that describe products and/or services of interest, the coordinates of the preference filter on the coordinate plane are retrieved. This is achieved by maintaining a preference filter matrix V_{P} that maintains the coordinates of each preference filter as it is updated. The preference filter matrix V_{P} is calculated by performing singular value decomposition on a word by preference filter matrix P that counts the relationship between the keywords specified in preference filter information. Similarly to the indexing of advertisement information in V_{A} upon entry or modification, consumer preference filters are also indexed for comparison against the same keywords and keyword groups. Upon retrieving the coordinates associated with the preference filter, call them X, and mapping X on the same coordinate plane as the new advertisement, call its retrieved coordinates Y, the similarity between the preference filter and advertisement may be determined via cosine similarity as cos Θ=X·Y/(|X∥Y|), where X·Y is the dot product between the two coordinate vectors and |·| represents the magnitude of the vector (Block 1665). The smaller the angle Θ between X and Y (i.e., as Θ approaches zero), the more similar the new advertisement information is to the keywords in the preference filter information (i.e., cos Θ approaches one). As a result, the cosine similarity between advertisement information 320′ and preference filter information 1410′ can determine the most similar advertisements to one or more preference filters set by one or more consumers. A sample coordinate plane is presented in FIG. 17 that illustrates the indexing of advertisement information 420′ and preference filter information 1410′ by keyword relationships 1715 into one or more keyword groupings 1720 or categories according to one embodiment of the present invention. If the similarity between the new advertisement information and the keywords in the preference filter is above a predetermined threshold for similarity required to deliver advertisement information to the consumer, the user identifier associated with the preference filter is recorded (Block 1670). Upon checking all preference filters, the relevant user identifiers are returned and the method 430′ is left (Block 1690). In another embodiment, region information may be specified without explicit selection of a merchant identifier, one or more merchant location identifiers or one or more keywords in the case that the consumer wishes to receive information from any and all merchants within the set region.

FIG. 18 is a flow diagram of an exemplary method 455′ for performing preference filter entry and modification operations in a manner that is consistent with the present invention. Authorized/authenticated input is accepted from the consumer (Block 1810). For the user input, the type of filter is determined (Block 1820). The first type of preference filter input is the specification of one or more merchant identifiers for which the consumer is interested in receiving information from (Block 1825). In Block 1830, the consumer is able to attach geolocation targeting information to the merchant to only find locations within a given region of interest specified by the consumer. For example, the consumer may be interested in receiving advertisements from all Starbucks locations in downtown San Francisco, Calif. It is important to note that various preference filters may have different geolocation targeting information associated with them based on user preference. As a result, while the consumer may be interested in receiving information from all Starbucks locations in downtown San Francisco, Calif., he/she may only be interested in receiving advertisements from Jimmy's Pizza locations within walking distance of his/her place of work. The consumer also has the option of applying the set preference filter to location-based advertisements to restrict the offers that they may receive to only the merchants specified here (Block 1835). As will be covered later, location-based advertisements allow merchants to reach out to nearby consumers with a highly discounted offer as an incentive to purchase their products or services.

The second type of preference filter input is the specification of one or more merchant location identifiers to specify specific merchant locations only that the consumer frequents (Block 1840). For example, the consumer may be very loyal to a specific sushi restaurant and is willing to receive information only from that location. The consumer can also limit location-based advertisements to specific merchant locations only (Block 1845).

The third type of preference filter input is the specification of one or more keywords that are used to describe products and/or services if the consumer is interested in receiving information on specific items (Block 1850). For example, the user may specify one or more product/service descriptors and/or identifiers such as “flights to Las Vegas” or “SONY XBR60LX900 3D HDTV.” The user may also wish to attach geolocation information to the entered keywords to restrict the search to one or more regions (Block 1855). For example, the user may be interested in being delivered only advertisement information relating to “Flights to Las Vegas” with geolocation targeting information “San Francisco, Calif.” to receive advertisement information only on flight deals to Las Vegas leaving from San Francisco, Calif. The consumer can also limit location-based advertisements to certain products or services such as “coffee” to receive only coffee-related offers from nearby merchants (Block 1860).

In Block 1865, the entered keywords in the preference filter information are indexed to update the word count in the preference filter matrix P and to calculate the new position of the preference filter on the coordinate plane. Consumer preference filters are indexed for comparison against the same keywords and keyword groups as advertisements to determine the similarity of preference filters that are set by consumers to advertisement information at the ad server. After counting keyword occurrences in the new preference filter information, and storing or updating the counting data in P, singular value decomposition is performed to update the position of the preference filter in V_{P}. Again, dimension reductionality is performed to emphasize the strongest word relationships in the preference filter information and remove noise. Block 1870 enables the consumer to specify one or more preference filters related to the input types discussed above, while if the input is completed, the method 455′ is returned.

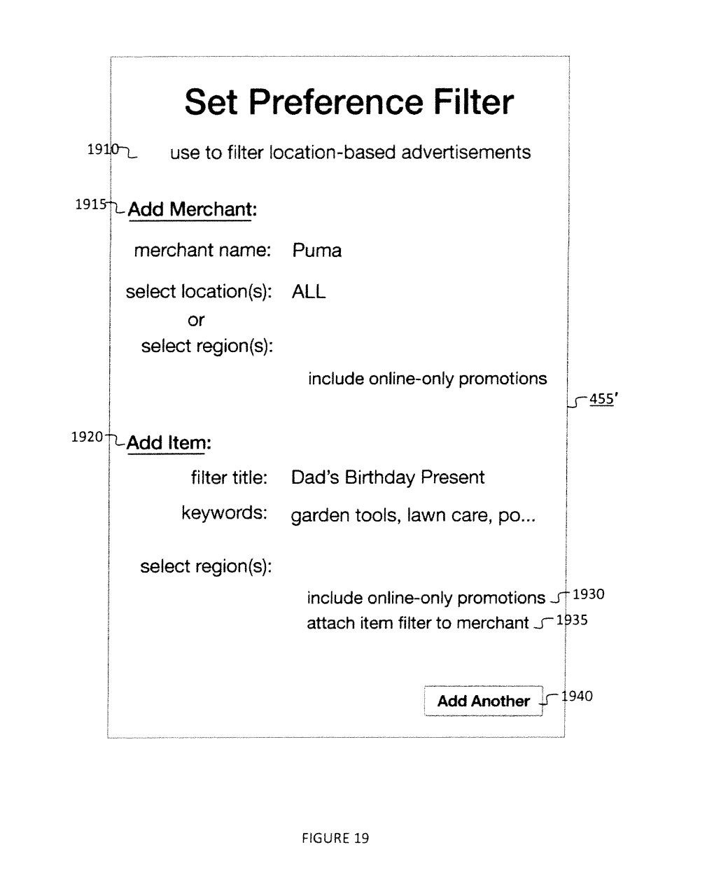

A screenshot of a consumer screen for preference filter entry and modification 455′ according to one embodiment of the present invention is presented in FIG. 19. As discussed, the consumer has the option 1910 to attach the set preference filter to location-based advertisements, while they are also able to add merchants 1915 by selecting specific merchants and/or merchant locations and within selected regions, if desired. They are also able to add items 1920 of interest specified by one or more keywords, while they may also attach regions to limit the search. In another embodiment, consumers have the ability to use the commerce network to access advertisements available on the Internet only by including online-only promotions 1930. In a third embodiment, consumers may also attach one or more keywords related to products and/or services of interest to the merchant 1935 to seek specific products at particular merchants. Consumers can also add any number of preference filters at any time using the button labeled “Add Another” 1940.

FIG. 20 is a flow diagram of an exemplary method 460′ for performing user client delivery & notification operations in a manner consistent with the present invention. Relevant user identifiers 440 associated with the relevant user request information 410′ are accepted (Block 2010). Recall from FIG. 5 that relevant user request information 410′ consists of an ad identifier and user information, etc. Consequently, relevant user identifiers 440 delivered to method 460′ consist of users for whom the new advertisement information is relevant at the time that the relevant user request information 410′ is received by the system. In this manner, the present invention improves advertising by delivering only those ads that consumers deem relevant to their current purchase preferences at any time, enabling consumers to manage ad information overload by automatically receiving only ad information they desire. As indicated by loop 2020-2050, an act is performed for each of one or more relevant users associated with the relevant user request information 410′. For each user identifier associated with the relevant user request information 410′, the user information 450′ is retrieved including one or more user profiles (e.g. device(s), social profile(s), etc.) registered in the user information, and the relevant ad is delivered to one or more user clients (Block 2030). The user associated with the relevant user request information 410′ is notified of the relevant ad delivery, i.e. “Future World has matched your sales filter for the SONY XBR60LX900 3D HDTV” (Block 2040). In one embodiment, relevant advertisements (consisting of all related inventory information as per advertisement information 340′ in FIG. 6) and notifications are delivered individually per new relevant ad to a consumer. In a second embodiment, all relevant advertisements are delivered in a single document in a list with a single notification informing the end user of new relevant advertisements based on the consumer's current preference filter information. In a third embodiment, relevant advertisements are delivered in a tile format to provide a smaller summary but a larger number of results on the page. In a fourth embodiment, relevant advertisements may be displayed in full page format per advertisement. After each of one or more relevant advertisements is delivered and the end user is notified, the method 460′ is left (Node 2060).

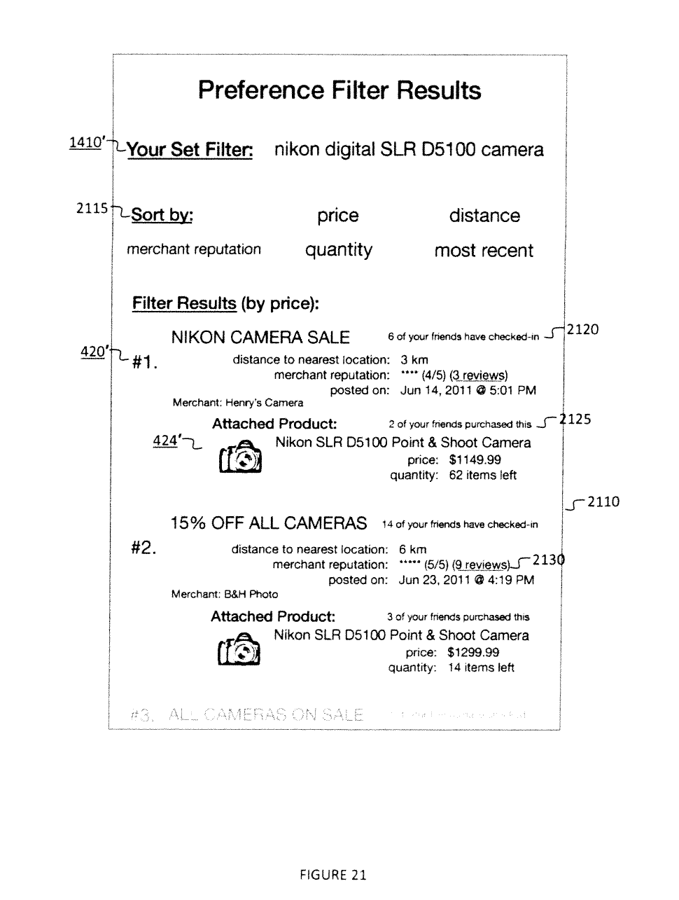

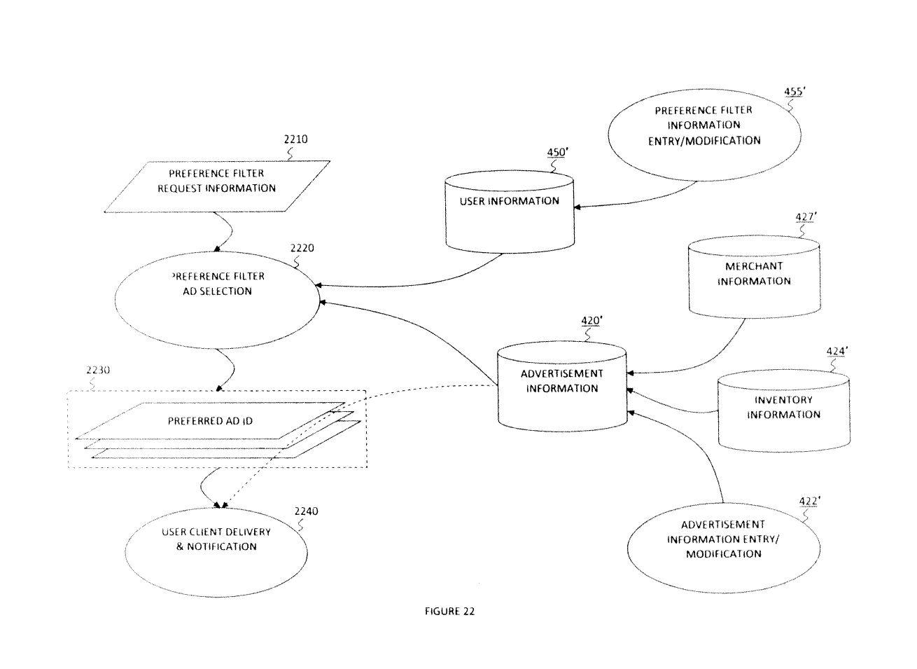

A screenshot of a consumer screen of a sample query and preference filter search results 2110 generated using advertisement information and preference filter information from the commerce network is presented in FIG. 21 according to one embodiment of the present invention. The preference filter search results 2110 may include the preference filter information 1410′. The preference filter search results 2110 may also include sorting information by price, distance to the nearest location, merchant reputation, quantity of a product available and time posted by most recent first. These five factors play a crucial role in the purchasing decision of a consumer and, as a result, the sort eases the decision-making process of the consumer by putting all the necessary information right at the forefront. While sorting by price information provides consumers with the ability to choose one or more locations at which a desired item is cheapest, distance to the nearest location allows the user to sort by closest locations first. Merchant reputation displays the average rating by one or more members of the commerce network. Furthermore, quantity information informs the consumer about the remaining number of items in stock at one or more locations and, as a result, illustrates the urgency, or lack thereof, of completing a transaction based on the item availability. Time posted describes how recently posted the advertisement is and gives consumers a sense of more valuable advertisements as they have just become available.

Preference filter search results contain advertisement information 420′, related inventory 424′, as well as aggregated location-based activity 2120 based on geolocation such as presence announcements by members using one or more user client devices at a sales event at one or more participating merchant locations associated with an advertisement 420′. Aggregated purchase information 2125 relating to items bought by peers may also be presented, while reviews 2130 of one or more merchants provide further information to the consumer.

FIG. 24 is a flow diagram of an exemplary method 2220′ for performing preference filter ad selection operations in a manner that is consistent with the present invention. In the first step, preference filter request information 2210′ is accepted (Block 2410). Request information may include, among other things, the user identifier containing the new preference filter information 1410′ for which a search shall be performed and advertisement information. With this request information, the advertisement information is retrieved (Block 2420). In Block 2430, the subset of valid advertisements is determined. The subset of valid advertisements is determined as those that are associated with one or more merchants, one or more specific merchant locations, or one or more participating merchant locations within one or more regions specified in the consumer preference filter information.

As indicated by loop 2440-2490, an act is performed for each advertisement deemed valid. For each valid advertisement associated with the preference filter request information 2210′, the type of filter set by the consumer is determined (Block 2450). If the filter type is associated with a merchant identifier, i.e. the preference filter is set to receive advertisement information by a merchant associated with new preference filter information, the first step involves verifying that the preference filter specifies the merchant identifier and the advertisement adheres to the geolocation targeting information attached by the consumer, if any (Block 2455). Upon verifying the merchant identifier, the preferred ad identifier is recorded (Block 2460). Similarly, if the filter type is associated with a merchant location identifier, i.e. the preference filter is set to receive advertisement information by a specific merchant location associated with the new preference filter information, the merchant location and attached geolocation targeting information, if any, is verified to ensure that the merchant location is located in one or more regions that may be specified by the consumer (Block 2465). Upon verifying the merchant location identifier, the preferred ad identifier is recorded (Block 2470).

For the delivery of preference filter results based on the specification of one or more keywords that describe products and/or services of interest, the new coordinates of the preference filter on the coordinate plane are determined. In the first step, the new counting data of keyword occurrences in the new preference filter information is updated in the keyword by preference filter matrix P, which maintains the keyword counts, where keywords in a stop-word list that do not affect meaning are excluded from the tally. This indexes the new preference filter information. The second step involves performing singular value decomposition on matrix P to determine three component sub-matrices, the word matrix U_{P}, the eigenvalue matrix Sp, and the preference filter matrix V_{P}^{T} where P=U_{P}×S_{P}×V_{P}^{T}, and choosing one or more top eigenvalues in S_{P} emphasizes the strongest word relationships in the preference filter information and remove noise in U_{P} and V_{P}^{T} via dimension reductionality. Similarly to the indexing of advertisement information in V_{A} upon entry or modification, consumer preference filters are also indexed for comparison against the same keywords and keyword groups. Upon retrieving the coordinates associated with the new preference filter, call them X, and mapping X on the same coordinate plane as the advertisement, call its retrieved coordinates Y, the similarity between the preference filter and advertisement may be calculated. This is determined via cosine similarity as cos Θ=X·Y/(|X∥Y|), where X·Y is the dot product between the two coordinate vectors and |·| represents the magnitude of the vector (Block 2475). The smaller the angle Θ between X and Y (i.e., as Θ approaches zero), the more similar the new advertisement information is to the keywords in the preference filter information (i.e., cos Θ approaches one). As a result, the cosine similarity between advertisement information 320′ and new preference filter information 1410′ can determine the most similar advertisements to one or more preference filters set by one or more consumers. If the similarity between the advertisement information and the keywords in the new preference filter is above a predetermined threshold for similarity required to deliver advertisement information to the consumer, the user identifier associated with the preference filter is recorded (Block 2480). Upon checking all valid advertisements, the preferred advertisement identifiers are returned and the method 2220′ is left (Block 2495).

In a second embodiment, region information may be specified without explicit selection of a merchant identifier, one or more merchant location identifiers or one or more keywords in the case that the consumer wishes to receive information from any and all merchants within the set region.

In a third embodiment, keywords of one or more consumer preference filters may be aggregated and viewed by one or more merchants of the commerce network, either on merchant account pages, by email, through statistics modules, etc. This approach informs merchants of products and services that consumers are seeking at that point in time to further improve the relevancy of advertisements. The first step of the process involves retrieving the preference filter matrix V_{P} and the advertisement matrix V_{A} that contain the coordinates of the consumer preference filters and the advertisement information on the coordinate plane, respectively. The second step involves determining the consumer preference filters that lie within a predetermined cosine similarity range to one or more advertisements posted by a merchant. The third step involves enumerating the keywords of the identified consumer preference filters for the purposes of determining the word occurrences in one or more of the identified consumer preference filter information stored in the system, where words in a stop-word list that do not affect meaning are excluded from the tally. Finally, the enumerated top word occurrences are displayed for view by one or more merchants of the commerce network.

FIG. 25 is a flow diagram of an exemplary method 2240′ for performing user client delivery & notification operations in a manner consistent with the present invention. Preferred ad identifiers 2230 associated with the preference filter request information 2210′ are accepted (Block 2510). Recall from FIG. 23 that preference filter request information 2210′ consists of a user identifier, preference filter information specified by the user, etc. Consequently, preferred ad identifiers 2230 delivered to method 2240′ consist of advertisements relevant to the preference filter information specified by the user at the time the preference filter request information 2210′ is received by the system. In this manner, the present invention improves advertising by delivering only those advertisements that consumers deem relevant to their current purchase preferences at a point in time, enabling consumers to manage ad information overload by automatically receiving only ad information that they seek. As indicated by loop 2520-2550, an act is performed for each of one or more preferred advertisements associated with the preference filter request information 2210′. For the user identifier associated with the preference filter request information 2210′, the user information 450′ is retrieved including one or more user profiles (e.g. device(s), social profile (s), etc.) registered in the user information, and the preferred ad is delivered to one or more user clients (Block 2530). The user associated with the preference filter request information 2210′ is also notified of the preferred advertisement delivery (Block 2540). In one embodiment, preferred advertisements and notifications are delivered individually to the consumer per new preferred advertisement determined. In a second embodiment, preferred advertisements are delivered in a single document in a list with a single notification informing the consumer of new relevant advertisements based on the consumer's current preference filter information. In a third embodiment, preferred advertisements are delivered in a tile format to provide a smaller summary but a larger number of results on the page. In a fourth embodiment, preferred advertisements may be displayed in full page format per advertisement. After each of one or more preferred advertisements is delivered and the consumer is notified, the method 360′ is left (Node 2560).

FIG. 29 is a flow diagram of an exemplary method 2630′ for location-based advertisement selection operations that is consistent with the present invention. Location-based ad request information is accepted (Block 2910). Recall from FIG. 27 that location-based advertisement request information 2610′ may include location-based advertisement information, user information (including user identifier, geolocation information and preference filter), merchant information (including geolocation information and maximum distance threshold), etc. In Block 2920, the location-based advertisement information 2620′, user information 450′ and merchant information 427′ are retrieved. As indicated by loop 2930-2950, an act is performed for each of one or more location-based advertisements at the ad server associated with the request. For the user identifier and merchant identifier associated with the request, geolocation information is accessed for both the user and merchant location. A decision block determines if the geographical distance between the merchant and user geolocations is less than or equal to the maximum distance threshold associated with the geolocation targeting information of the merchant (Block 2942), Recall from FIG. 28 that the geolocation targeting information associated with the location-based advertisement 2620′ may specify a range extending outwards from the merchant geolocation position in a circular area thereby defining a valid operating region for the transmission of location-based advertisements 2620′. Thus, the decision block may determine if the location-based advertisement 2620′ is valid based on whether or not the user geolocation is within the operating region. If the location-based ad is valid, a decision block determines whether or not the user has an active preference filter set (Block 2944). If the user preference filter is not set, the ad may be deemed relevant to the user and the ad identifier is recorded (Block 2946). If the preference filter is active, another decision block may determine whether or not the location-based advertisement is relevant based on the geolocation targeting information specified in the user's preference filter information (Block 2948). Recall from FIG. 19 that the user may choose to associate one or more merchants, one or more merchant locations, one or more keywords and/or one or more regions with location-based advertisements. For example, a user may set a preference filter to only receive location-based offers from “cafes” or “coffee shops”. Users may only be delivered an offer from a merchant if both the user and merchant are within each of their desired geolocation targeting limits of each other and the offer adheres to the content of the user's set preference filter, in this case “cafes” or “coffee shops”.

If the decision block deems that the location-based advertisement 2620′ is relevant, the ad identifier is recorded (Block 2946). After each of the one or more location-based advertisements 2620′ has been processed, the relevant location-based ad identifiers are returned and the method 2630′ is left (Block 2960).

FIG. 30 is a flow diagram of an exemplary method 2622′ for location-based ad information entry/modification operations in a manner that is consistent with the present invention. Recall from FIG. 28 that location-based advertising information 2620′ may include ad creative content (or a reference to ad creative content), landing page link, expiry/duration information, description information, merchant location information, geolocation targeting information, etc. The first step is the acceptance of authorized input (Block 3010). As indicated by event block 3020, various branches of the method 2622′ may be performed in response to various input types. If the merchant inputs or updates geolocation targeting information associated with the location-based advertising information 2620′ (Block 3030), the merchant adds or updates the range of the location-based advertisement to define an operating region extending outwards from the merchant geolocation in a circular area. The merchant may also input or modify advertisement and inventory information associated with the location-based advertising information 2620′ consisting of description information including one or more descriptors, product/service identifiers, expiry information, one or more merchant locations that apply to the location-based advertisement for the purposes of delivering a highly discounted offer to a nearby consumer as an incentive to purchase the merchant's products or services (Block 3040). Referring back to event block 3020, if the merchant enters an exit command, the method 2622′ is exited (Node 3050).

FIG. 31 is a flow diagram of an exemplary method 2650′ for user client delivery & permission prompt operations in a manner that is consistent with the present invention. One or more location-based ad identifiers are accepted (Block 3110). These ad identifiers represent all ads that meet the geolocation targeting information of both the merchant and consumer, and adhere to the consumer's preference filter information if the consumer has decided to apply the preference filter to location-based advertisements. As indicated by loop 3120-3140, an act is performed for each of one or more accepted advertisements to prompt the user for permission prior to displaying the location-based advertisement 2620′ to the consumer screen. The goal of the permission prompt is to not only reduce the amount of interruption advertising that causes information overload, but to give users control over the advertising they do consume at the time that they want to consume it. A screenshot of a consumer screen illustrating the display of the permission prompt to the consumer with two buttons, labeled “View” 3210 and “Dismiss” 3215, prior to the display of a location-based advertisement impression 2620′ is presented in FIG. 32 according to one embodiment of the present invention. The permission prompt may invite a user response to view or dismiss an offer that is used by nearby merchants to provide incentives to a user to purchase one or more products or services of the merchant (Block 3133). As a result, the prompt may include inventory information 424′, merchant location information 1010′ and merchant reputation information 1110′ to provide the consumer with some minimal information to help them decide whether or not to provide permission for the advertisement.

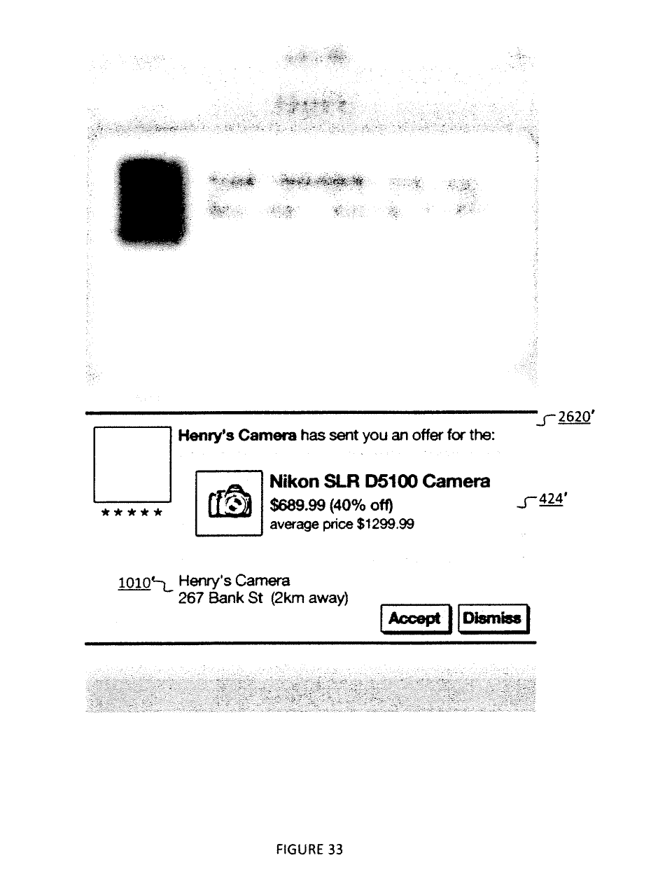

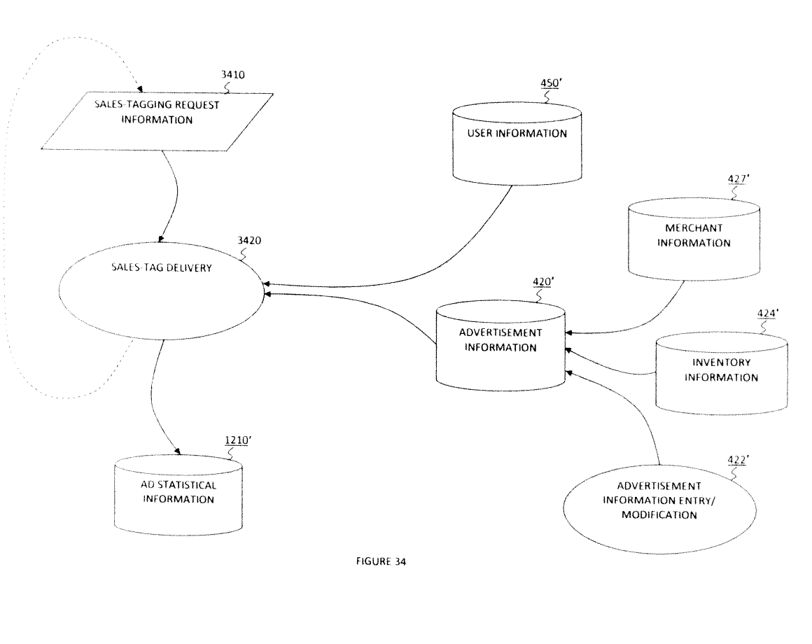

A decision block may decide based on the input from the user at the permission prompt whether or not to display the advertisement (Block 3136). Recall from FIG. 13 that one or more user profiles (devices, social profile(s), clients, etc.) may be registered in user information 450′. If permission was granted by the user, an impression of the offer may be displayed on the registered user profiles in, for example, the form of a rectangular banner advertisement (Block 3138). In another embodiment, the offer is only displayed on the user client from which permission was granted. A screenshot of a consumer screen illustrating the display on the location-based advertisement 2620′ following user-granted permission is presented in FIG. 33 and provides the offer for inventory information 424′ and the merchant location's geolocation information 1010′ associated with the advertisement. Once the loop 3120-3140 is executed to completion, the method 2650′ is left (Block 3150).

In a third embodiment, the location-based advertisement can be uniquely identified by a combination of a unique location-based advertisement identifier, applicable merchant location identifier(s) associated with the advertisement and the merchant identifier. In this embodiment, if the user gives permission for an advertisement to be displayed for a single merchant location, the system may recognize the action as declaring user interest in this combination. The ad may subsequently be considered valid for all combinations of the location-based advertisement identifier, one or more applicable merchant location identifiers and the merchant identifier as above. For example, consider a user walking down a street in San Francisco who receives a permission prompt on a user client device from Coffee Bean, a local coffee shop that is 0.2 miles away, for an offer of a free coffee. Assuming that the user's preference filter deems this ad to be relevant, if the user decides to view the offer from the Coffee Bean location, the system may consider that the combination of the free coffee offer from all locations of Coffee Bean of the merchant is valid. If the same user passes a second Coffee Bean location, and the user's preference filter still deems the offer as relevant, the user may receive another offer for a free coffee. However, in this embodiment, once the user chooses to dismiss an offer at a permission prompt received at a later time, i.e. if the user has had enough free coffee from Coffee Bean, the user may no longer receive offers for the free coffee offer from any Coffee Bean location, i.e. the combination of the location-based advertisement identifier, applicable merchant location identifier(s) and merchant identifier may be deemed no longer valid by the system. Other location-based ads (e.g., “receive a free coffee when you purchase a bagel”) from Coffee Bean may be deemed relevant, i.e. they create a different unique location-based advertisement identifier, applicable merchant location identifier(s) and merchant identifier combination, if the ads adhere to the user's preference filter. However, as mentioned, users can specify merchant locations and keywords of products or services of interest to only receive relevant advertisements related to specified information at any time.

FIG. 36 is a flow diagram of an exemplary method 3420′ for sales-tag delivery in a social media context in a manner that is consistent with the present invention. Request for the sales-tag delivery is accepted in Block 3610. As indicated by loop 3620-3670, an act is performed for each of one or more sales-tag recipients. Recall from FIG. 35 that sales-tag request information 3410′ consists of a recommending user identifier, one or more recipient user identifiers, an ad identifier, and a personal message. Also recall that sales-tag recipients are connected to the recommending user in a social graph within one degree of separation. A decision block 3630 determines if the recommending user is an existing application user. e.g. contains an active and valid user profile at the server, or a non-application user. If a sales-tag recipient is a non-application user, the recipient is sent an application invitation, either by social profile through social network integration, email, text message, etc. (Block 3640). If the sales-tag recipient is an existing application user, the recipient is sent a notification consisting of the recommending user information, personal message, associated advertisement and inventory information of the ad identifier of the sales-tag, and the landing page link of the ad on one or more user profiles and ad statistics are updated for the tagging user (Block 3650). Once all recipients have been serviced and loop 3620-3660 is complete, the method 3420′ is left (Block 3670).

### Exemplary Apparatus

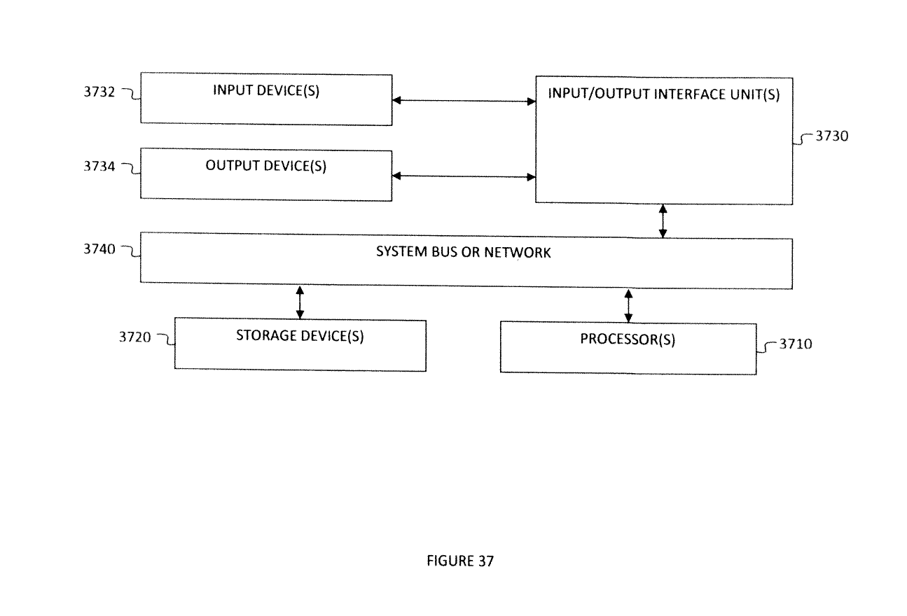

FIG. 37 is high-level block diagram of a machine that may perform one or more of the operations discussed above. The machine may include one or more processors 3710, one or more storage devices 3720, one or more input/output interface units 3730, and one or more system buses and/or networks 3740 for facilitating the communication of information between the coupled elements. One or more input devices 3732 and one or more output devices 3734 may be coupled with the one or more input/output interfaces 3730.

The one or more processors 3710 may execute machine-executable instructions (e.g., C or C++ programming language) to affect one or more aspects of the present invention. At least a portion of the machine executable instructions may be stored (temporarily or more permanently) on the one or more storage devices 3720 and/or may be received from an external source via one or more input interface units 3730.

In one embodiment, the machine may be one or more conventional personal computers. In this case, the processing units 3710 may be one or more microprocessors. The bus 3740 may include a system bus. The storage devices 3720 may include system memory, such as read only memory (ROM) and/or random access memory (RAM). The storage devices 3720 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 3732, such as a keyboard and pointing device (e.g., a mouse), for example. Other input devices such as a microphone, a joystick, a game pad, a satellite dish, a scanner, or the like, may also (or alternatively) be included. These and other input devices are often connected to the processing unit(s) 3710 through an appropriate interface 3730 coupled to the system bus 3740. The output devices 3734 may include a monitor or other type of display device, which may also be connected to the system bus 3740 via an appropriate interface. In addition to (or instead of) the monitor, the personal computer may include other (peripheral) output devices (not shown), such as speakers and printers for example.

### CONCLUSIONS

The present invention allows for the specification and delivery of relevant advertising information in a commerce network by providing systems and methods for merchants to improve the user targeting relevancy, geographical relevancy and time relevancy of their advertising material. Through the exemplary methods covered by this invention, the usefulness, efficiency and performance of advertisements is improved.

What is claimed is:

1. A computer-implemented method that consolidates description information and inventory information associated with an advertisement for the organization of advertisement information of one or more merchants in a commerce network for access by one or more consumers, the method comprising:
displaying description information of one or more advertisements in the form of text, images, ad creative art or video on the consumer's screen for the purpose of disclosing the contents of the advertisements to one or more consumers over one or more telecommunication services; and
attaching inventory information to the advertisement in the form of one or more products or services offered by the merchant in association with the advertisement.

2. The method of claim 1 further comprising attaching quantity information related to inventory information available for purchase in association with the advertisement.

3. The method of claim 1 further comprising attaching price information related to inventory information available for purchase in association with the advertisement.

4. The method of claim 1 further comprising attaching merchant information in the form of name information and logo creative content associated with the advertisement.

5. The method of claim 4 further comprising attaching merchant reputation information in the form of an average merchant rating submitted by one or more consumers.

6. The method of claim 4 furthering comprising attaching merchant geolocation information in the form of country, city, address, zip/postal code, and latitude and longitude coordinate information associated with one or more participating merchant locations at which the advertisement information is applicable.

7. The method of claim 6 further comprising sorting one or more participating merchant locations in association with the advertisement by geolocation information in the form of the distance of one or more participating locations to the consumer's geolocation represented by the position of a user client device at the time of the sort.

8. The method of claim 1 further comprising retrieving, aggregating and publishing purchase information of one or more consumers related to inventory information associated with the advertisement.

9. The method of claim 4 further comprising retrieving, aggregating and publishing review information of one or more consumers related to merchant information associated with the advertisement.

10. The method of claim 7 further comprising retrieving, aggregating and publishing location-based activity based on geolocation such as presence announcements by consumers using one or more user client devices at a sales event at one or more participating merchant locations associated with the advertisement.

11. The method of claim 1 wherein new consolidated advertisement information that is posted in one or more ad servers of the commerce network is indexed by the correlation between word patterns using natural language processing by latent semantic analysis to determine the context of words specified within advertisement information, the method comprising:
counting word occurrences in the description information and inventory information associated with the consolidated advertisement information where words in a stop-word list that do not affect meaning are excluded from the tally;
storing or updating the counting data of word occurrences in a word by advertisement matrix A;
performing singular value decomposition on matrix A to determine three component sub-matrices: the word matrix U_{A}, the eigenvalue matrix S_{A}, and the advertisement matrix V_{A}^{T}; and
choosing one or more top eigenvalues in S_{A} to emphasize the strongest word relationships in the consolidated advertisements and remove noise in U_{A} and V_{A}^{T} via dimension reductionality.

12. The method of claim 11 further comprising the plotting of the coordinates of each word in the U_{A} matrix and each advertisement in the V_{A}^{T} matrix on a coordination plane to create “concepts,” or clusters that group words and advertisements by category based on the strength in word relationships.

13. The method of claim 1 wherein advertisement information is displayed in the form of search results in response to a user search query for advertisement information, the method comprising:
receiving, from the system, the user search query consisting of one or more keywords;
retrieving, from the system, the matrix V_{A}^{T} that contains the coordinates of the advertisements on the coordinate plane;
mapping the user search query into a document Q for comparison against the advertisements on the coordinate plane by finding Q=qₜU_{A}S_{A}⁻¹, where qₜ maps the keywords of the user search query using a “1” for each keyword in U_{A} that exists in the user search query and a “0” for each keyword in U_{A} that does not exist in the user search query;
retrieving the coordinates of the user search query X stored in Q;
determining the cosine similarity between the coordinates of the user search query X and the coordinates of each advertisement Y in V_{A}^{T} as cos Θ=X·Y/(|X∥Y|), where X·Y is the dot product between the two coordinate vectors and |·| represents the magnitude of the vector, and the smaller the angle Θ between X and Y (i.e., as Θ approaches zero), the more similar an advertisement information is to the keywords in the user search query (i.e., cos Θ approaches one);
ranking advertisements in order of cosine similarity to the keywords in the user search query and denote those advertisements as user search results; and
delivering user search results to the user.

14. The method of claim 13 wherein one or more user search results are displayed in tile, list or full page format for the display of consolidated advertisement information.

15. The method of claim 1 wherein advertisement information is interactive whereby embedded description, inventory, quantity, price, merchant, merchant reputation, geolocation, purchase, review and location-based activity information are accessed or clicked through by hyperlinks, tag keywords, word clouds, bar codes or Quick Response (QR) codes displayed as part of the advertisement on a consumer screen.

16. The use of the method of claim 1 wherein the commerce network is a social network with consumers and merchants acting as members, the use comprising:
retrieving, for the purpose of using social relationships, social graph information of one or more consumers from either the system or third party social network application programming interface;
determining the degree of separation between two members of the social network based on the minimum number of intermediate member relationships between the respective members;
retrieving the members within a predetermined degree of separation from a given member of the social network;
delivering a sales-tag of an advertisement including a personal message in text, image or video format from one member to another member within one degree of separation of the recommending member;
providing payment solutions over one or more telecommunications services for the purchase of products and services available in limited quantities in association with the advertisement;
consolidating quantity information, geolocation information and inventory information to determine one or more participating locations in association with an advertisement at which one or more products and services added by a consumer to a shopping cart are available with quantity in stock;
aggregating purchase information related to inventory information associated with an advertisement of one or more members and publishing the aggregated purchase information in association with the advertisement;
aggregating review information related to merchant information associated with an advertisement of one or more members and publishing the aggregated review information; or
aggregating location-based activity based on geolocation such as presence announcements by members using one or more user client devices at a sales event at one or more participating merchant locations associated with an advertisement.

17. The use of the method of claim 1 wherein the commerce network is a telecommunications network such as a mobile network with consumers and merchants acting as members and accessing the advertising network through one or more telecommunication services, the method comprising:
retrieving, for the purpose of using social relationships, social graph information of one or more consumers from either the system or third party social network application programming interface;
maintaining a graph of relationships between one or more consumers and one or more merchants through member identifiers and approved connections by the system;
determining the degree of separation between two members of the social network based on the minimum number of intermediate member relationships between the respective members;
retrieving the members within a predetermined degree of separation from a given member of the social network;
delivering a sales-tag of an advertisement including a personal message in text, image or video format from one member to another member within one degree of separation of the recommending member;
providing payment solutions over one or more telecommunications services for the purchase of products and services available in limited quantities in association with the advertisement;
consolidating quantity information, geolocation information and inventory information to determine one or more participating locations in association with an advertisement at which one or more products and services added by a consumer to a shopping cart are available with quantity in stock;
aggregating purchase information related to inventory information associated with an advertisement of one or more members and publishing the aggregated purchase information in association with the advertisement;
aggregating review information related to merchant information associated with an advertisement of one or more members and publishing the aggregated review information; or
aggregating location-based activity based on geolocation such as presence announcements by members using one or more user client devices at a sales event at one or more participating merchant locations associated with an advertisement.

18. A computer-implemented method for the delivery of relevant advertisement information to a consumer, the method comprising the consumer specifying one or more merchant identifiers in preference filter information for the purpose of receiving advertisements from one or more merchants of interest in a commerce network.

19. The method of claim 18 further comprising the consumer specifying one or more merchant location identifiers in preference filter information for the purpose of receiving advertisements from one or more merchant locations of interest in the commerce network.

20. The method of claim 18 further comprising the consumer specifying one or more regions in preference filter information for the purpose of receiving advertisements from one or more specific geographical areas of interest in the commerce network.

21. The method of claim 18 further comprising the consumer specifying one or more keywords in preference filter information for the purpose of receiving advertisements related to products or services of interest defined by the specified keywords in the commerce network.

22. The method of claim 18 further comprising the consumer attaching geolocation targeting information to one or more merchant identifiers or keywords specified in preference filter information to narrow the search for relevant advertisements.

23. The method of claim 18 further comprising the consumer specifying permission information in the preference filter information to turn the delivery of preference filter search results on and off at will to improve the time relevancy of received advertisement information to the consumer.

24. The method of claim 18 wherein new preference filter information that is added or updated in the commerce network is indexed by the correlation between word patterns using natural language processing by latent semantic analysis, the method comprising:
counting keyword occurrences in the new preference filter information where keywords in a stop-word list that do not affect meaning are excluded from the tally;
storing or updating the counting data of keyword occurrences in a word by preference filter matrix P;
performing singular value decomposition on matrix P to determine three component sub-matrices: the word matrix U_{P}, the eigenvalue matrix S_{P}, and the preference filter matrix V_{P}^{T}; and
choosing one or more top eigenvalues in Sp to emphasize the strongest word relationships in the preference filter information and remove noise in U_{P} and V_{P}^{T} via dimension reductionality.

25. The method of claim 24 further comprising plotting of the coordinates of each keyword in the U_{P} matrix and each preference filter in the V_{P}^{T} matrix on the coordination plane to determine the similarity of preference filters to existing “concepts,” or clusters that group keywords and preference filter information by category based on the strength in keyword relationships.

26. The method of claim 18 wherein a search is performed by the system to deliver preference filter search results whenever new preference filter information is added or updated in the commerce network, the method comprising:
retrieving, from the system, the coordinates of the new preference filter information X determined via indexing of the new preference filter information;
retrieving, from the system, the advertisement matrix V_{A}^{T};
determining the cosine similarity between the coordinates of the new preference filter keyword mapping X and the coordinates of each advertisement Y in V_{A}^{T} as cos Θ=X·Y/(|X∥Y|), where X·Y is the dot product between the two coordinate vectors and |·| represents the magnitude of the vector, and the smaller the angle Θ between X and Y (i.e., as Θ approaches zero), the more similar an advertisement information is to the keywords in the new preference filter information (i.e., cos Θ approaches one);
accepting those advertisements that satisfy a predetermined threshold for similarity necessary for the delivery of advertisement information;
ranking accepted advertisements in order of cosine similarity to preference filter keywords from highest to lowest;
denoting the accepted advertisements as preference filter search results; and
delivering preference filter search results to the user.

27. The method of claim 26 further comprising:
retrieving advertisement information V_{A}^{T} in matrix form associated with one or more merchants specified in the new preference filter information;
denoting the advertisement information as preference filter search results; and
delivering preference filter search results to the user.

28. The method of claim 26 further comprising, after retrieving the advertisement matrix V_{A}^{T}, the step of retrieving the subset of advertisements V_{A}^{T}* which have participating locations within regions set, if any, in the consumer's preference filter information for processing.

29. The method of claim 26 further comprising:
retrieving advertisement information associated with one or more merchant locations specified in the new preference filter information;
denoting the advertisement information as preference filter search results; and
delivering preference filter search results to the user.

30. The method of claim 18 wherein a search is performed by the system to deliver preference filter search results whenever new advertisement information is posted in one or more ad servers of the commerce network, the method comprising:
retrieving, from the system, the coordinates of the new advertisement information Y determined via indexing of the new advertisement information;
retrieving, from the system, the preference filter matrix V_{P}^{T};
retrieving the subset of consumer preference filters V_{P}^{T}* by analytical means;
determining the cosine similarity between the coordinates of the each preference filter mapping X in V_{P}^{T}* and the coordinates of the new advertisement information Y as cos Θ=X·Y/(|X∥Y|), where X·Y is the dot product between the two coordinate vectors and |·| represents the magnitude of the vector, and the smaller the angle Θ between X and Y (i.e., as Θ approaches zero), the more similar the new advertisement information is to the keywords in the preference filter information (i.e., cos Θ approaches one);
accepting those consumer preference filters for which the new advertisement information satisfies the predetermined threshold for similarity necessary for the delivery of advertisement information;
denoting the advertisement as a preference filter search result for those accepted consumer preference filters; and
delivering the preference filter search result to the users associated with the accepted consumer preference filters.

31. The method of claim 26 further comprising:
delivering preference filter search results to one or more user device clients associated with the consumer information; and
notifying consumers on one or more user clients of new preference filter search results.

32. The method of claim 30 wherein the analytical means is selected from the group consisting of consumer preference filters that have specified the merchant, one or more merchant locations that are specified as participating merchant locations in association with the advertisement, and one or more regions in which the merchant has participating locations in association with the advertisement.

33. The method of claim 26 wherein the basis for sorting of the preference filter search results is selected from the group consisting of:
price information related to inventory information associated with the preference filter search results in ascending or descending order;
geolocation information in terms of the distance from the consumer's geolocation represented by the position of a user client device at the time of the search to the geolocations of one or more participating merchant locations associated with the advertisement in ascending or descending order;
quantity information, if applicable, in terms of remaining units of inventory associated with the preference filter search results available for purchase in ascending or descending order;
merchant reputation information in terms of the average merchant rating associated with the preference filter search results in ascending or descending order; and
time posted for advertisements associated with preference filter search results by most recently posted or latest posted.

34. The method of claim 26 wherein the purchase information related to inventory information associated with a preference filter search result of one or more members is aggregated and published in association with the preference filter search result.

35. The method of claim 26 wherein the review information related to merchant information associated with a preference filter search result by one or more members is aggregated and published in association with the preference filter search result.

36. The method of claim 26 wherein the location-based activity based on geolocation such as presence announcements by members using one or more user client devices at a sales event at one or more participating merchant locations associated with a preference filter search result is aggregated and published in association with the preference filter search result.

37. The method of claim 18 wherein sales-tagging further delivers relevant advertising information between members of the commerce network, the method comprising:
receiving, from a member, a sales-tagging request including the associated advertisement identifier, and one or more member identifiers to whom the recommending member is requesting the recommendation be sent to;
accepting the sales-tagging request, after verifying the recommending member is valid, and storing the recommendation in the system; and
transmitting the recommendation in the form of the associated advertisement information to one or more user client devices associated with the accounts of the receiving members of the recommendation.

38. The method of claim 37 further comprising:
receiving a personal message in the form of text, images or video in association with the sales-tagging request to be sent with the recommendation to one or more member identifiers to whom the recommending member is requesting a recommendation be sent to; and
transmitting the personal message in association with the sales-tag of an advertisement to one or more user client devices associated with the accounts of the receiving members of the recommendation.

39. The method of claim 37 further comprising adding a system-generated personal message to the recommendation, stating the nature of the recommendation if one is not provided by the recommending member as part of the sales-tagging request.

40. The method of claim 37 further comprising delivering a notification to receiving members of the sales-tag on one or more user client devices associated with the accounts of those members.

41. The method of claim 18 further comprising aggregating keywords of preference filter information of one or more consumers and displaying the aggregated keywords for view by one or more merchants of the commerce network to inform them of products and services that consumers are seeking at that point in time, the method comprising:
retrieving, from the system, the preference filter matrix V_{P}^{T} and the advertisement matrix V_{A}^{T} that contain the coordinates of the consumer preference filters and the advertisement information on the coordinate plane, respectively;
determining the consumer preference filters that lie within a predetermined cosine similarity range to one or more advertisements posted by a merchant;
enumerating the keywords of the identified consumer preference filters for the purposes of determining the word occurrences in one or more of the identified consumer preference filter information stored in the system where words in a stop-word list that do not affect meaning are excluded from the tally; and
displaying the enumerated top word occurrences for view by one or more merchants of the commerce network.

42. A computer-implemented method for the rendering of a location-based advertisement that is used by nearby merchants to provide incentives to the consumer to purchase one or more products or services of the merchant, the method comprising:
displaying description information associated with the location-based advertisement in the form of text, images, ad creative art or video on the consumer's screen; and
attaching merchant information in the form of merchant geolocation information associated with the location-based advertisement to display the distance of the merchant from the consumer's geolocation at the time of rendering the location-based advertisement.

43. The system of claim 42 further comprising prompting a consumer for permission on one or more client devices over one or more telecommunications services in the form of a rectangular permission prompt with two buttons, labeled “View” and “Dismiss,” prior to displaying an impression of the location-based advertisement.

44. The method of claim 43 further comprising embedding the permission-prompt with a predetermined time-out value such that, if the permission-prompt is displayed for the duration of the time-out value, the advertisement expires and disappears.

45. The method of claim 42 further comprising attaching inventory information of one or more products or services offered by the merchant for purchase in association with the location-based advertisement.

46. The method of claim 42 further comprising attaching price information of one or more products or services offered by the merchant for purchase in association with the location-based advertisement.

47. The method of claim 42 further comprising attaching merchant reputation information in the form of rating information by one or more consumers who have rated the merchant.

48. The method of claim 42 further comprising the location-based advertisement information adhering to the preference filter information set by the consumer prior to displaying a location-based advertisement from the merchant on one or more consumer screens.

49. The method of claim 42 further comprising using the consumer's geolocation to ensure that the consumer is within a valid operating region of a merchant prior to displaying a location-based advertisement from the merchant on one or more consumer screens.

50. The method of claim 49 further comprising defining the valid operating region of the merchant as based on maximum range information associated with the merchant information extending outwards in all directions from the merchant's geolocation, thereby creating a circular area as the valid operating region.
